(19) United States
(12) Patent Application Publication
(10) Pub. No.: US 2021/0368152 A1
(43) Pub. Date: Nov. 25, 2021

(54) INFORMATION PROCESSING APPARATUS, INFORMATION PROCESSING METHOD, AND PROGRAM

(71) Applicant: SONY CORPORATION, TOKYO (JP)

(72) Inventors: MITSURU NISHIBE, TOKYO (JP); ATSUSHI ISHIHARA, TOKYO (JP); KOICHI KAWASAKI, TOKYO (JP)

(21) Appl. No.: 17/252,831

(22) PCT Filed: May 28, 2019
(86) PCT No.: PCT/JP2019/021074

§ 371 Date: Dec. 16, 2020

(30) Foreign Application Priority Data
Jun. 26, 2018 (JP) 2018-120497

(51) Int. Cl. H04N 13/117; G02B 27/01; G02B 27/00

(52) U.S. Cl. CPC H04N 13/117; G02B 2027/0178; G02B 27/0093; G02B 27/017

(57) ABSTRACT

An information processing apparatus includes an acquisition unit (101) configured to acquire first information regarding a recognition result of at least one of a position or an orientation of a viewpoint, and a control unit (117) configured to project a target object on a display region on the basis of the first information and cause display information to be presented to the display region according to a result of the projection, in which the control unit projects the object on a first partial region and a second partial region included in the display region on the basis of the first information according to the recognition result at timings different from each other.

### TECHNICAL FIELD

The present disclosure relates to an information processing apparatus, an information processing method, and a program.

### BACKGROUND ART

In recent years, the advancement of image recognition technology has enabled recognition of the position and orientation of a real object (that is, an object in a real space) included in an image captured by an imaging device. As one of application examples of such object recognition, there is a technology called augmented reality (AR). By using the AR technology, virtual content in various modes such as text, icons, and animations (hereinafter, referred to as “virtual object”) can be superimposed on an object in the real space (hereinafter referred to as “real object”) and a superimposed image can be presented to a user. For example, Patent Document 1 discloses an example of a technology of presenting virtual content to a user using an AR technology.

### CITATION LIST

### Patent Document

Patent Document 1: International Publication No. 2017/183346

### SUMMARY OF THE INVENTION

### Problems to be Solved by the Invention

By the way, a processing load regarding drawing of the virtual object is relatively high, depending on display information to be presented as the virtual object, and there are some cases where a delay occurs from the start of the drawing of the virtual object to output as the display information. Therefore, for example, when the position or orientation of a viewpoint of the user changes due to the delay during time until the drawn virtual object is presented to the user, there are some cases where a gap is caused in a relative position or orientation relationship between the viewpoint and the position where the drawn virtual object is superimposed. Such a gap may be recognized by the user as a gap of the position in the space where the virtual object is superimposed, for example. This applies not only to AR but also similarly applies to so-called virtual reality (VR) for presenting a virtual object in an artificially constructed virtual space.

Therefore, the present disclosure proposes a technology that enables presentation of information according to the position or orientation of a viewpoint in a more favorable mode.

### Solutions to Problems

According to the present disclosure, there is provided an information processing apparatus including: an acquisition unit configured to acquire first information regarding a recognition result of at least one of a position or an orientation of a viewpoint; and a control unit configured to project a target object on a display region on the basis of the first information and cause display information to be presented to the display region according to a result of the projection, in which the control unit projects the object on a first partial region and a second partial region included in the display region on the basis of the first information according to the recognition result at timings different from each other.

Furthermore, according to the present disclosure, there is provided an information processing method including: by a computer, acquiring first information regarding a recognition result of at least one of a position or an orientation of a viewpoint; and projecting a target object on a display region on the basis of the first information and causing display information to be presented to the display region according to a result of the projection, in which the object is projected on a first partial region and a second partial region included in the display region on the basis of the first information according to the recognition result at timings different from each other.

Furthermore, according to the present disclosure, there is provided a program for causing a computer to: acquire first information regarding a recognition result of at least one of a position or an orientation of a viewpoint; and project a target object on a display region on the basis of the first information and cause display information to be presented to the display region according to a result of the projection, in which the object is projected on a first partial region and a second partial region included in the display region on the basis of the first information according to the recognition result at timings different from each other.

### Effects of the Invention

As described above, according to the present disclosure, there is provided a technology for enabling presentation of information according to the position or orientation of a viewpoint in a more favorable mode.

Note that the above-described effect is not necessarily limited, and any of effects described in the present specification or another effect that can be grasped from the present specification may be exerted in addition to or in place of the above-described effect.

### BRIEF DESCRIPTION OF THE DRAWINGS

FIG. 1 is an explanatory view for describing an example of a schematic configuration of an information processing system according to an embodiment of the present disclosure.

FIG. 2 is an explanatory view for describing an example of a schematic configuration of an input/output device according to the present embodiment.

FIG. 3 is an explanatory diagram for describing an outline of an example of an influence of a delay between movement of a viewpoint and presentation of information.

FIG. 4 is an explanatory diagram for describing an example of a method of reducing an influence of a delay between movement of a viewpoint and presentation of information.

FIG. 5 is an explanatory diagram for describing an outline of the example of an influence of a delay between movement of a viewpoint and presentation of information.

FIG. 6 is an explanatory diagram for describing an outline of an example of processing of drawing an object having three-dimensional shape information as two-dimensional display information.

FIG. 7 is an explanatory diagram for describing an outline of an example of processing of drawing an object having three-dimensional shape information as two-dimensional display information.

FIG. 8 is an explanatory diagram for describing a basic principle of processing regarding drawing and presentation of display information in the information processing system according to the embodiment.

FIG. 9 is an explanatory diagram for describing an example of processing regarding correction of a presentation position of display information.

FIG. 10 is a block diagram illustrating an example of a functional configuration of the information processing system according to the embodiment.

FIG. 11 is a flowchart illustrating an example of a flow of a series of processing of the information processing system according to the embodiment.

FIG. 12 is an explanatory diagram for describing an outline of an example of the information processing system according to the embodiment.

FIG. 13 is an explanatory diagram for describing an outline of an example of the information processing system according to the embodiment.

FIG. 14 is a functional block diagram illustrating an example of a hardware configuration of an information processing apparatus configuring an information processing system according to an embodiment of the present disclosure.

FIG. 15 is a functional block diagram illustrating an example of a hardware configuration in a case where an information processing apparatus configuring an information processing system according to an embodiment of the present disclosure is implemented as a chip.

### MODE FOR CARRYING OUT THE INVENTION

Favorable embodiments of the present disclosure will be described in detail below with reference to the accompanying drawings. Note that, in the present specification and the drawings, redundant description of constituent elements having substantially the same functional configurations is omitted by giving the same reference numerals.

Note that the description will be given in the following order.

1. Outline

1.1. Schematic Configuration

1.2. Configuration of Input/Output Device

1.3. Principle of Self-position Estimation

2. Study on Delay Between Movement of Viewpoint and Presentation of Information

3. Technical Characteristics

3.1. Outline of Processing of Drawing Object as Display Information

3.2. Basic Principle of Processing Regarding Drawing and Presentation of Display Information

3.3. Functional Configuration

3.4. Processing

3.5. Modification

3.6. Example

4. Hardware Configuration

5. Conclusion

### 1. Outline

### 1.1. Schematic Configuration

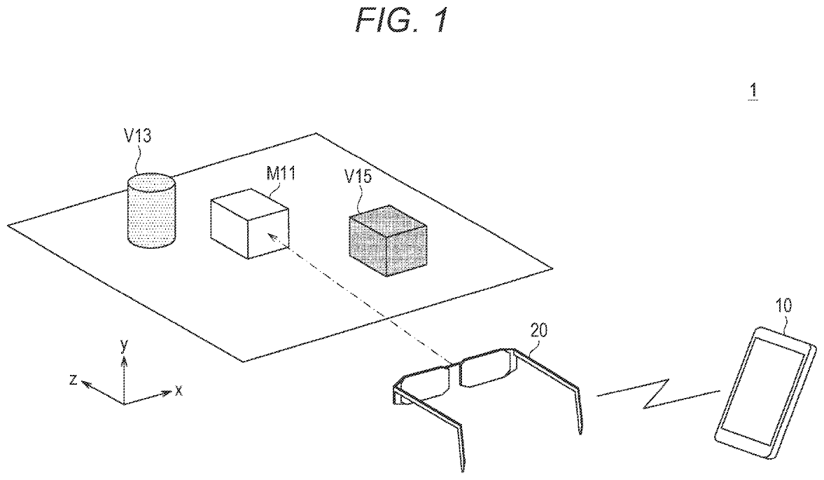

First, an example of a schematic configuration of an information processing system according to an embodiment of the present disclosure will be described with reference to FIG. 1. FIG. 1 is an explanatory view for describing an example of a schematic configuration of an information processing system according to an embodiment of the present disclosure. In FIG. 1, reference numeral M11 schematically represents an object (that is, a real object) located in a real space. Furthermore, reference numerals V13 and V15 schematically represent virtual content (that is, virtual objects) presented to be superimposed in the real space. In other words, an information processing system 1 according to the present embodiment superimposes the virtual objects on an object in the real space such as the real object M11 on the basis of a so-called augmented reality (AR) technology, for example, and presents the superimposed objects to a user. Note that, in FIG. 1, both the real object and the virtual objects are presented for easy understanding of the characteristics of the information processing system according to the present embodiment.

As illustrated in FIG. 1, an information processing system 1 according to the present embodiment includes an information processing apparatus 10 and an input/output device 20. The information processing apparatus 10 and the input/output device 20 are able to transmit and receive information to and from each other via a predetermined network. Note that the type of network connecting the information processing apparatus 10 and the input/output device 20 is not particularly limited. As a specific example, the network may be configured by a so-called wireless network such as a network based on a Wi-Fi (registered trademark) standard. Furthermore, as another example, the network may be configured by the Internet, a dedicated line, a local area network (LAN), a wide area network (WAN), or the like. Furthermore, the network may include a plurality of networks, and some of the networks may be configured as a wired network.

The input/output device 20 is a configuration for obtaining various types of input information and presenting various types of output information to the user who holds the input/output device 20. Furthermore, the presentation of the output information by the input/output device 20 is controlled by the information processing apparatus 10 on the basis of the input information acquired by the input/output device 20. For example, the input/output device 20 acquires, as the input information, information for recognizing the real object M11, and outputs the acquired information to the information processing apparatus 10. The information processing apparatus 10 recognizes the position of the real object M11 in the real space on the basis of the information acquired from the input/output device 20, and causes the input/output device 20 to present the virtual objects V13 and V15 on the basis of the recognition result. With such control, the input/output device 20 can present, to the user, the virtual objects V13 and V15 such that the virtual objects V13 and V15 are superimposed on the real object M11 on the basis of the so-called AR technology. Note that, in FIG. 1, the input/output device 20 and the information processing apparatus 10 are illustrated as devices different from each other. However, the input/output device 20 and the information processing apparatus 10 may be integrally configured. Furthermore, details of the configurations and processing of the input/output device 20 and the information processing apparatus 10 will be separately described below.

An example of the schematic configuration of the information processing system according to the embodiment of the present disclosure has been described with reference to FIG. 1.

### 1.2. Configuration of Input/Output Device

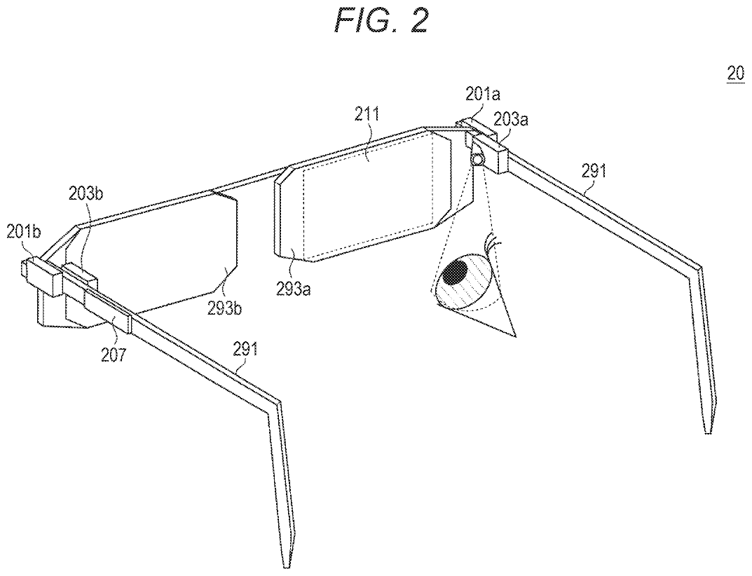

Next, an example of a schematic configuration of the input/output device 20 according to the present embodiment illustrated in FIG. 1 will be described with reference to FIG. 2. FIG. 2 is an explanatory view for describing an example of a schematic configuration of the input/output device according to the present embodiment.

The input/output device 20 according to the present embodiment is configured as a so-called head-mounted device worn on at least part of the head of the user and used by the user. For example, in the example illustrated in FIG. 2, the input/output device 20 is configured as a so-called eyewear-type (glasses-type) device, and at least either a lens 293a or a lens 293b is configured as a transmission-type display (output unit 211). Furthermore, the input/output device 20 includes first imaging units 201a and 201b, second imaging units 203a and 203b, an operation unit 207, and a holding unit 291 corresponding to a frame of the glasses. The holding unit 291 holds the output unit 211, the first imaging units 201a and 201b, the second imaging units 203a and 203b, and the operation unit 207 to have a predetermined positional relationship with respect to the head of the user when the input/output device 20 is mounted on the head of the user. Furthermore, although not illustrated in FIG. 2, the input/output device 20 may be provided with a sound collection unit for collecting a voice of the user.

Here, a more specific configuration of the input/output device 20 will be described. For example, in the example illustrated in FIG. 2, the lens 293a corresponds to a lens on a right eye side, and the lens 293b corresponds to a lens on a left eye side. In other words, the holding unit 291 holds the output unit 211 such that the output unit 211 (in other words, the lenses 293a and 293b) is located in front of the eyes of the user in the case where the input/output device 20 is mounted.

The first imaging units 201a and 201b are configured as so-called stereo cameras and are held by the holding unit 291 to face a direction in which the head of the user faces (in other words, the front of the user) when the input/output device 20 is mounted on the head of the user. At this time, the first imaging unit 201a is held near the user's right eye, and the first imaging unit 201b is held near the user's left eye. The first imaging units 201a and 201b capture a subject located in front of the input/output device 20 (in other words, the real object located in the real space) from different positions from each other on the basis of such a configuration. Thereby, the input/output device 20 acquires images of the subject located in front of the user and can calculate a distance to the subject from the input/output device 20 on the basis of a parallax between the images respectively captured by the first imaging units 201a and 201b.

Note that the configuration and method are not particularly limited as long as the distance between the input/output device 20 and the subject can be measured. As a specific example, the distance between the input/output device 20 and the subject may be measured on the basis of a method such as multi-camera stereo, moving parallax, time of flight (TOF), or structured light. Here, the TOF is a method of obtaining an image (so-called distance image) including a distance (depth) to a subject on the basis of a measurement result by projecting light such as infrared light on the subject and measuring a time required for the projected light to be reflected by the subject and return, for each pixel. Furthermore, the structured light is a method of obtaining a distance image including a distance (depth) to a subject on the basis of change in a pattern obtained from a capture result by irradiating the subject with the pattern of light such as infrared light and capturing the pattern. Furthermore, the moving parallax is a method of measuring a distance to a subject on the basis of a parallax even in a so-called monocular camera. Specifically, the subject is captured from different viewpoints from each other by moving the camera, and the distance to the subject is measured on the basis of the parallax between the captured images. Note that, at this time, the distance to be subject can be measured with more accuracy by recognizing a moving distance and a moving direction of the camera using various sensors. Note that the configuration of the imaging unit (for example, the monocular camera, the stereo camera, or the like) may be changed according to the distance measuring method.

Furthermore, the second imaging units 203a and 203b are held by the holding unit 291 such that eyeballs of the user are located within respective imaging ranges when the input/output device 20 is mounted on the head of the user. As a specific example, the second imaging unit 203a is held such that the user's right eye is located within the imaging range. The direction in which the line-of-sight of the right eye is directed can be recognized on the basis of an image of the eyeball of the right eye captured by the second imaging unit 203a and a positional relationship between the second imaging unit 203a and the right eye, on the basis of such a configuration. Similarly, the second imaging unit 203b is held such that the user's left eye is located within the imaging range. In other words, the direction in which the line-of-sight of the left eye is directed can be recognized on the basis of an image of the eyeball of the left eye captured by the second imaging unit 203b and a positional relationship between the second imaging unit 203b and the left eye. Note that the example in FIG. 2 illustrates the configuration in which the input/output device 20 includes both the second imaging units 203a and 203b. However, only one of the second imaging units 203a and 203b may be provided.

The operation unit 207 is a configuration for receiving an operation on the input/output device 20 from the user. The operation unit 207 may be configured by, for example, an input device such as a touch panel or a button. The operation unit 207 is held at a predetermined position of the input/output device 20 by the holding unit 291. For example, in the example illustrated in FIG. 2, the operation unit 207 is held at a position corresponding to a temple of the glasses.

Furthermore, the input/output device 20 according to the present embodiment may be provided with, for example, an acceleration sensor and an angular velocity sensor (gyro sensor) and may be able to detect movement of the head of the user wearing the input/output device 20 (in other words, movement of the input/output device 20 itself). As a specific example, the input/output device 20 may recognize a change in at least either the position or orientation of the head of the user by detecting components in a yaw direction, a pitch direction, and a roll direction as the movement of the head of the user.

The input/output device 20 according to the present embodiment can recognize changes in its own position and orientation in the real space according to the movement of the head of the user on the basis of the above configuration. Furthermore, at this time, the input/output device 20 can present the virtual content (in other words, the virtual object) to the output unit 211 to superimpose the virtual content on the real object located in the real space on the basis of the so-called AR technology. Note that an example of a method for the input/output device 20 to estimate its own position and orientation in the real space (that is, self-position estimation) will be described below in detail.

Note that examples of a head-mounted display (HMD) device applicable as the input/output device 20 include a see-through HMD, a video see-through HMD, and a retinal projection HMD.

The see-through HMD uses, for example, a half mirror or a transparent light guide plate to hold a virtual image optical system including a transparent light guide or the like in front of the eyes of the user, and displays an image inside the virtual image optical system. Therefore, the user wearing the see-through HMD can take the external scenery into view while viewing the image displayed inside the virtual image optical system. With such a configuration, the see-through HMD can superimpose an image of the virtual object on an optical image of the real object located in the real space according to the recognition result of at least one of the position or orientation of the see-through HMD on the basis of the AR technology, for example. Note that a specific example of the see-through HMD includes a so-called glasses-type wearable device in which a portion corresponding to a lens of glasses is configured as a virtual image optical system. For example, the input/output device 20 illustrated in FIG. 2 corresponds to an example of the see-through HMD.

In a case where the video see-through HMD is mounted on the head or face of the user, the video see-through HMD is mounted to cover the eyes of the user, and a display unit such as a display is held in front of the eyes of the user. Furthermore, the video see-through HMD includes an imaging unit for capturing surrounding scenery, and causes the display unit to display an image of the scenery in front of the user captured by the imaging unit. With such a configuration, the user wearing the video see-through HMD has a difficulty in directly taking the external scenery into view but the user can confirm the external scenery with the image displayed on the display unit. Furthermore, at this time, the video see-through HMD may superimpose the virtual object on an image of the external scenery according to the recognition result of at least one of the position or orientation of the video see-through HMD on the basis of the AR technology, for example.

The retinal projection HMD has a projection unit held in front of the eyes of the user, and an image is projected from the projection unit toward the eyes of the user such that the image is superimposed on the external scenery. More specifically, in the retinal projection HMD, an image is directly projected from the projection unit onto the retinas of the eyes of the user, and the image is imaged on the retinas. With such a configuration, the user can view a clearer video even in a case where the user has myopia or hyperopia. Furthermore, the user wearing the retinal projection HMD can take the external scenery into view even while viewing the image projected from the projection unit. With such a configuration, the retinal projection HMD can superimpose an image of the virtual object on an optical image of the real object located in the real space according to the recognition result of at least one of the position or orientation of the retinal projection HMD on the basis of the AR technology, for example.

Furthermore, an HMD called immersive HMD can also be mentioned in addition to the above-described examples. The immersive HMD is mounted to cover the eyes of the user, and a display unit such as a display is held in front of the eyes of the user, similarly to the video see-through HMD. Therefore, the user wearing the immersive HMD has a difficulty in directly taking an external scenery (in other words, scenery of a real world) into view, and only an image displayed on the display unit comes into view. With such a configuration, the immersive HMD can provide an immersive feeling to the user who is viewing the image. Therefore, the immersive HMD can be applied in a case of presenting information mainly based on a virtual reality (VR) technology, for example.

An example of the schematic configuration of the input/output device according to the embodiment of the present disclosure has been described with reference to FIG. 2.

### 1.3. Principle of Self-Position Estimation

Next, an example of a principle of a technique for the input/output device 20 to estimate its own position and orientation in the real space (that is, self-position estimation) when superimposing the virtual object on the real object will be described.

As a specific example of the self-position estimation, the input/output device 20 captures an image of a marker or the like having a known size presented on the real object in the real space, using an imaging unit such as a camera provided in the input/output device 20. Then, the input/output device 20 estimates at least one of its own relative position or orientation with respect to the marker (and thus the real object on which the marker is presented) by analyzing the captured image. Note that the following description will be given focusing on the case where the input/output device 20 estimates its own position and orientation. However, the input/output device 20 may estimate only one of its own position or orientation.

Specifically, a relative direction of the imaging unit with respect to the marker (and thus the input/output device 20 provided with the imaging unit) can be estimated according to the direction of the marker (for example, the direction of a pattern and the like of the marker) captured in the image. Furthermore, in the case where the size of the marker is known, the distance between the marker and the imaging unit (that is, the input/output device 20 provided with the imaging unit) can be estimated according to the size of the marker in the image. More specifically, when the marker is captured from a farther distance, the marker is captured smaller. Furthermore, a range in the real space captured in the image at this time can be estimated on the basis of an angle of view of the imaging unit. By using the above characteristics, the distance between the marker and the imaging unit can be calculated backward according to the size of the marker captured in the image (in other words, a ratio occupied by the marker in the angle of view). With the above configuration, the input/output device 20 can estimate its own relative position and orientation with respect to the marker.

Furthermore, a technology so-called simultaneous localization and mapping (SLAM) may be used for the self-position estimation of the input/output device 20. SLAM is a technology for performing self-position estimation and creation of an environmental map in parallel by using an imaging unit such as a camera, various sensors, an encoder, and the like. As a more specific example, in SLAM (in particular, Visual SLAM), a three-dimensional shape of a captured scene (or subject) is sequentially restored on the basis of a moving image captured by the imaging unit. Then, by associating a restoration result of the captured scene with a detection result of the position and orientation of the imaging unit, creation of a map of a surrounding environment and estimation of the position and orientation of the imaging unit (and thus the input/output device 20) in the environment are performed. Note that the position and orientation of the imaging unit can be estimated as information indicating relative change on the basis of detection results of various sensors by providing the various sensors such as an acceleration sensor and an angular velocity sensor to the input/output device 20, for example. Of course, the estimation method is not necessarily limited to the method based on the detection results of the various sensors such as an acceleration sensor and an angular velocity sensor as long as the position and orientation of the imaging unit can be estimated.

Under the above configuration, the estimation result of the relative position and orientation of the input/output device 20 with respect to the known marker, which is based on the imaging result of the marker by the imaging unit, may be used for initialization processing or position correction in SLAM described above, for example. With the configuration, the input/output device 20 can estimate its own position and orientation with respect to the marker (and thus the real object on which the marker is presented) by the self-position estimation based on SLAM reflecting results of the initialization and position correction executed before even in a situation where the marker is not included in the angle of view of the imaging unit.

Furthermore, the above description has been made focusing on the example of the case of performing the self-position estimation mainly on the basis of the imaging result of the marker. However, a detection result of another target other than the marker may be used for the self-position estimation as long as the detection result can be used as a reference for the self-position estimation. As a specific example, a detection result of a characteristic portion of an object (real object) in the real space, such as a shape or pattern of the object, may be used for the initialization processing or position correction in SLAM.

An example of the principle of the technique for the input/output device 20 to estimate its own position and orientation in the real space (that is, self-position estimation) when superimposing the virtual object on the real object has been described. Note that the following description will be given on the assumption that the position and orientation of the input/output device 20 with respect to an object (real object) in the real space can be estimated on the basis of the above-described principle, for example.

### 2. Study on Delay Between Movement of Viewpoint and Presentation of Information

Next, an outline of a delay between movement of a viewpoint (for example, the head of the user) and presentation of information in the case of presenting the information to the user according to a change in the position or orientation of the viewpoint, such as AR or VR, will be described.

In the case of presenting information to the user according to a change in the position or orientation of a viewpoint, a delay from when the movement of the viewpoint is detected to when the information is presented (so-called motion-to-photon latency) may affect an experience of the user. As an example, in the case of presenting a virtual object as if the virtual object exists in front of the user according to the orientation of the head of the user, a series of processing of recognizing the orientation of the head from a detection result of the movement of the head of the user and presenting the information according to the recognition result may require time. In such a case, a gap according to the processing delay may occur between the movement of the head of the user and a change in a field of view according to the movement of the head (that is, a change in the information presented to the user), for example.

In particular, the delay becomes apparent as a gap between a real world and the virtual object in a situation where the virtual object is superimposed on the real world such as AR. Therefore, even if the gap that becomes apparent as an influence of the delay is a slight amount that is hardly perceived by the user in the case of VR, the gap may be easily perceived by the user in the case of AR.

As an example of a method of reducing the influence of the delay, there is a method of reducing the delay by increasing a processing speed (frame per second: FPS). However, in this case, a higher-performance processor such as CPU or GPU is required in proportion to improvement of the processing speed. Furthermore, a situation where power consumption increases and a situation where heat is generated can be assumed with the improvement of the processing speed. In particular, a device for implementing AR or VR, such as the input/output device 20 described with reference to FIG. 2, is assumed to operate by power supply from a battery, and the increase in power consumption has a more significant influence. Furthermore, in a device such as the input/output device 20 worn on a part of the body of the user, the influence of the heat generation (for example, the influence on the user who wears the device) tends to become more apparent due to the characteristic of the use method, as compared with other devices. Furthermore, in the device such as the input/output device 20, a space where a device such as a processor is provided is limited, as compared with a stationary device, and application of a high-performance processor may be difficult.

Furthermore, as another example of the method of reducing the influence of the delay, there is a method of two-dimensionally correcting a presentation position of information within a display region according to the position or orientation of the viewpoint at a presentation timing when presenting the information to the user. As an example of the technology of two-dimensionally correcting the presentation position of information, there is a technology called “timewarp”.

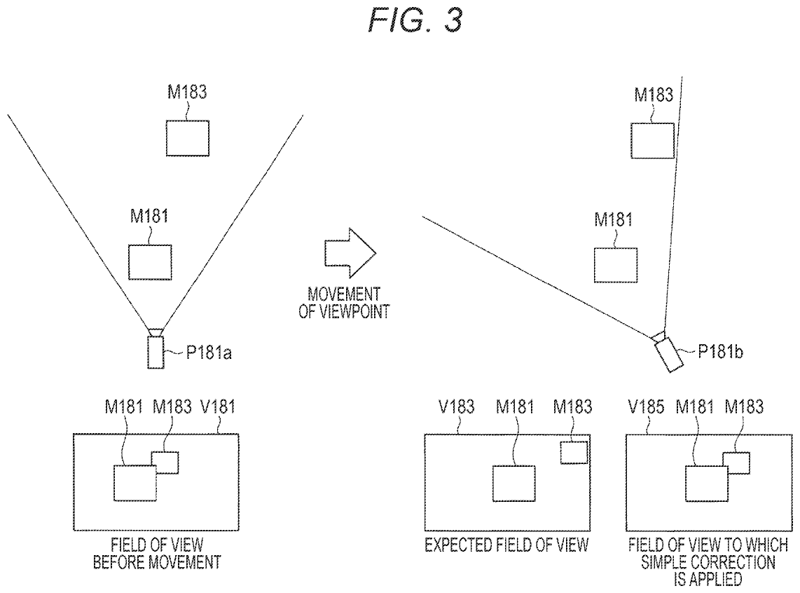

In the meantime, the information cannot be necessarily presented in an originally expected mode only by two-dimensionally correcting the presentation position of the information. For example, FIG. 3 is an explanatory diagram for describing an outline of an example of the influence of the delay between movement of the viewpoint and presentation of information, and illustrates an example of an output in the case of two-dimensionally correcting the presentation position of the information according to the position and orientation of the viewpoint.

In FIG. 3, reference numerals P181a and P181b each schematically represent the position and orientation of the viewpoint. Specifically, reference numeral P181a represents the position and orientation of the viewpoint before movement. Furthermore, reference numeral P181b represents the position and orientation of the viewpoint after movement. Note that, in the following description, the viewpoints P181a and P181b may be simply referred to as “viewpoint(s) P181” unless otherwise particularly distinguished. Furthermore, reference numerals M181 and M183 each schematically represent an object (for example, a virtual object) to be displayed in the display region. That is, FIG. 3 illustrates an example of the case of presenting images of the objects M181 and M183 in the case of viewing the objects M181 and M183 from the viewpoint P181 according to a three-dimensional positional relationship between the viewpoint P181 and the objects M181 and M183.

For example, reference numeral V181 schematically represents a video corresponding to the field of view in the case of viewing the objects M181 and M183 from the viewpoint P181a before movement. The images of the objects M181 and M183 presented as the video V181 are drawn as two-dimensional images according to position and orientation relationship between the viewpoint P181a and the objects M181 and M183 according to the position and orientation of the viewpoint P181a.

Furthermore, reference numeral V183 schematically represents an originally expected video as the field of view in the case of viewing the objects M181 and M183 from the viewpoint P181b after movement. In contrast, reference numeral V185 schematically illustrates a video corresponding to the field of view from the viewpoint P181, which is presented by two-dimensionally correcting the presentation positions of the images of the objects M181 and M183 presented as the video V181 according to the movement of the viewpoint P181. As can be seen by comparing the video V183 with the video V185, the objects M181 and M183 are located at different positions in a depth direction with respect to the viewpoint P181, and thus moving amounts are originally different in the field of view with the movement of the viewpoint P181. Meanwhile, the moving amounts in the field of view of the objects M181 and M183 become equal when the images of the objects M181 and M183 in the video V181 are regarded as a series of images, and the presentation position of the series of images is simply two-dimensionally corrected according to the movement of the viewpoint P181, as in the video V185. Therefore, in the case of two-dimensionally correcting the presentation position of the images of the objects M181 and M183, there are some cases where a logically broken video is visually recognized as the field of view from the viewpoint P181b after movement.

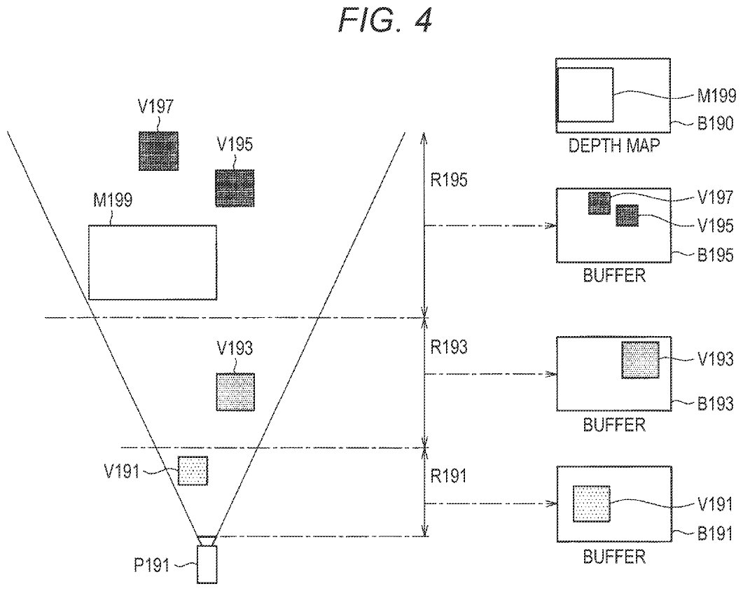

As an example of a method for solving such a problem, there is a method of dividing a region corresponding to the field of view based on the viewpoint into a plurality of regions along the depth direction, and correcting the presentation position of the image of the object (for example, the virtual object) for each region. For example, FIG. 4 is an explanatory diagram for describing an example of the method of reducing an influence of a delay between movement of a viewpoint and presentation of information, and illustrates an outline of an example of the method of correcting the presentation position of an object image for each region divided along the depth direction.

In the example illustrated in FIG. 4, a region corresponding to the field of view based on a viewpoint P191 is divided into a plurality of regions R191, R193, and R195 along the depth direction, and buffers different from each other are associated with the respective divided regions. Note that the buffers associated with the regions R191, R193, and R195 are referred to as buffers B191, B193, and B195, respectively. Further, in a case of assuming use in AR, a buffer B190 for holding a depth map according to a measurement result of the distance between a real object in the real space and the viewpoint may be provided separately from the buffers B191, B193, and B195.

With the above configuration, an image of each virtual object is drawn in the buffer corresponding to the region in which the virtual object is presented. That is, the image of the virtual object V191 located in the region R191 is drawn in the buffer B191. Similarly, the image of the virtual object V193 located in the region R193 is drawn in the buffer B193. Furthermore, the images of the virtual objects V195 and V197 located in the area R195 are drawn in the buffer B195. Furthermore, the depth map according to the measurement result of the distance between a real object M199 and the viewpoint P191 is held in the buffer B190.

Then, in a case where the viewpoint P191 has moved the presentation position of the image of the virtual object drawn in each of the buffers B191 to B195 is individually corrected for each buffer according to the change in the position or orientation of the viewpoint P191. With such a configuration, it becomes possible to individually correct the presentation position of the image of each virtual object in consideration of the moving amount according to the distance between the viewpoint P191 and each of the virtual objects V191 to V197. Furthermore, even in a situation where some virtual object is shielded by the real object or another object with the movement of the viewpoint P191, presentation of the image of each virtual object can be controlled in consideration of the shielding. That is, according to the example illustrated in FIG. 4, information can be presented to the user in a less logically broken mode than the case described with reference to FIG. 3.

Meanwhile, in the example described with reference to FIG. 4, the accuracy related to the correction of the presentation position of the image according to the position in the depth direction may change according to the number of buffers. That is, there is a possibility that an error of the presentation position of display information becomes larger as the number of buffers is smaller. Furthermore, since the image of the object is drawn in each buffer regardless of whether or not information is eventually presented, there is a possibility that the processing cost increases in proportion to the number of buffers. Furthermore, since the images drawn in the plurality of buffers are eventually combined and presented, the cost of the combining processing is required.

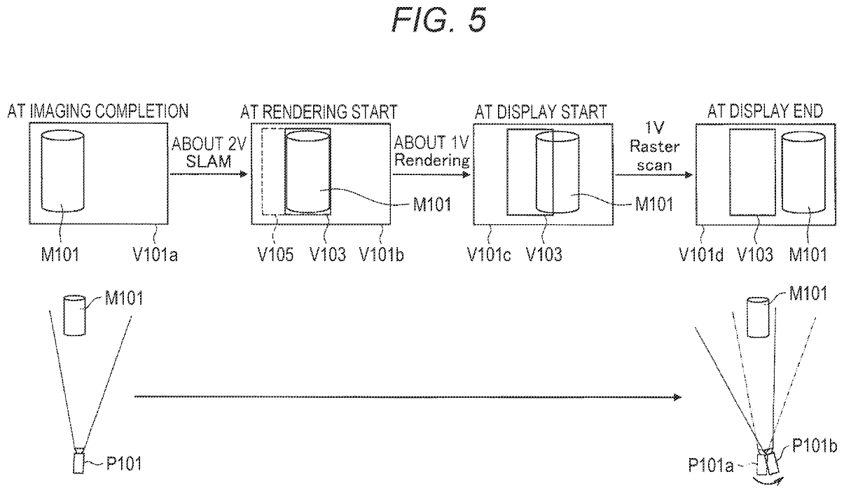

Furthermore, a situation in which the position or orientation of the viewpoint changes during execution of processing of drawing an image or processing of displaying a drawing result can be assumed. For example, FIG. 5 is an explanatory diagram for describing an outline of the example of an influence of a delay between movement of a viewpoint and presentation of information. Specifically, FIG. 5 illustrates an example of a flow of processing regarding presentation of display information V103 in the case of presenting an image of a virtual object as the display information V103 to be superimposed on a real object M101 in the real space according to the position and orientation of a viewpoint P101 on the basis of the AR technology. More specifically, FIG. 5 illustrates an example of a case where the position and orientation of the viewpoint P101 further change in a series of flow where the position and orientation of the viewpoint P101 are recognized according to an imaging result of the image of the real space, the display information V103 is rendered according to a result of the recognition, and then the display information V103 is displayed in the display region. In FIG. 5, reference numeral P101a represents the position and orientation of the viewpoint P101 before movement. Furthermore, reference numeral P101b represents the position and orientation of the viewpoint P101 after movement.

Reference numeral V101a schematically represents a video within the field of view from the viewpoint P101 (in other words, a video image visually recognized by the user) at the time of completion of capturing the image of the real object M101. The position and orientation of the viewpoint P101 at the time of capturing the image of the real object M101 (that is, the position and orientation of the viewpoint P101a before movement) are recognized by using the technology of self-position estimation such as SLAM, for example, on the basis of the image of the real object M101.

Reference numeral V101b schematically represents a video within the field of view from the viewpoint P101 at the start of rendering the display information V103. In the video V101b, the position of the real object M101 in the video (that is, in the field of view) has changed from the state illustrated as the video V101a with the change in the position and orientation of the viewpoint P101 from the completion of capturing the image of the real object M101. Note that, in the example illustrated in FIG. 5, the presentation position of the display information V103 is corrected according to the change in the position and orientation of the viewpoint P101 at the start of rendering. Reference numeral V105 schematically represents the presentation position of the display information V103 before the presentation position is corrected. That is, the presentation position V105 corresponds to the position of the real object M101 in the video V101a at the time of completion of capturing the image. At this point of time, the position of the real object M101 and the position at which the display information V103 is presented are substantially coincident in the video V101b with the above correction.

Reference numeral V101c schematically represents a video within the field of view from the viewpoint P101 at the start of processing regarding display of the display information V103 (for example, drawing the display information V103 or the like) Furthermore, reference numeral V101d schematically represents a video within the field of view from the viewpoint P101 at the end of the processing regarding display of the display information V103. In each of the videos V101c and V101d, the position of the real object M101 in the video (that is, in the field of view) has changed from the state illustrated as the video V101b with the change in the position and orientation of the viewpoint P101 from the start of rendering the display information V103.

As can be seen by comparing the videos V101b to V101d, since the position and orientation of the viewpoint P101 change from the start of rendering to the end of display of the display information V103 according to the result of the rendering, the position of the real object M101 in the field of view from the viewpoint P101 changes. Meanwhile, the position at which the display information V103 is presented in the field of view does not change from the start of rendering. Therefore, in the example illustrated in FIG. 5, a delay time from the start of rendering of the display information V103 to the end of display of the display information V103 becomes apparent as a gap between the position of the real object M101 and the presentation position of the display information V103 in the field of view from the viewpoint P101.

In view of the foregoing, the present disclosure proposes a technology for enabling presentation of information in a more favorable mode (for example, in a less logically broken mode) even in the case where the position or orientation of the viewpoint changes in the situation where the information is presented according to the position or orientation of the viewpoint.

### 3. Technical Characteristics

Hereinafter, technical characteristics of the information processing system according to the present disclosure will be described.

### 3.1. Outline of Processing of Drawing Object as Display Information

First, an outline of an example of processing of drawing an object having three-dimensional shape information (for example, a virtual object) as two-dimensional display information in a situation where the object is presented to an output unit such as a display as the display information.

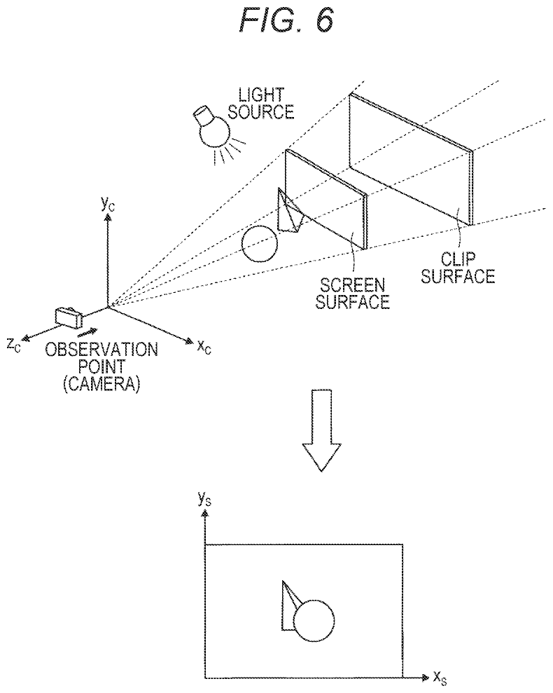

For example, FIG. 6 is an explanatory diagram for describing an outline of an example of processing of drawing an object having three-dimensional shape information as two-dimensional display information. Note that the processing illustrated in FIG. 6 can be implemented by processing called “vertex shader”, for example.

As illustrated in FIG. 6, in the case of presenting an object having three-dimensional shape information as two-dimensional display information, a target object is projected on a screen surface defined according to the field of view (angle of view) from an observation point with respect to the observation point (that is, viewpoint) in a three-dimensional space. That is, the screen surface can correspond to a projection surface. At this time, a color of the object when the object is drawn as the two-dimensional display information may be calculated according to a positional relationship between a light source defined in the three-dimensional space and the object. The two-dimensional shape of the object, the color of the object, the two-dimensional position at which the object is presented (that is, the position on the screen surface), and the like are calculated according to the relative positional relationship among the observation point, the object, and the screen surface according to the position and orientation of the observation point.

Note that the example in FIG. 6 illustrates an example of a projection method in a case where a clip surface is located on a back side of the target object, that is, in a case where the object is projected on the screen surface located on the back side. In contrast, as another example of the projection method, there is a method in which the clip surface is located on a front side of the target object, and the object is projected on the screen surface located on the front side. In the following description, the case where the clip surface is located on the back side of the target object will be described as an example, as illustrated in FIG. 6. However, the object projection method is not necessarily limited, and the case where the clip surface is located on the front side of the object similarly works unless technical discrepancies occur.

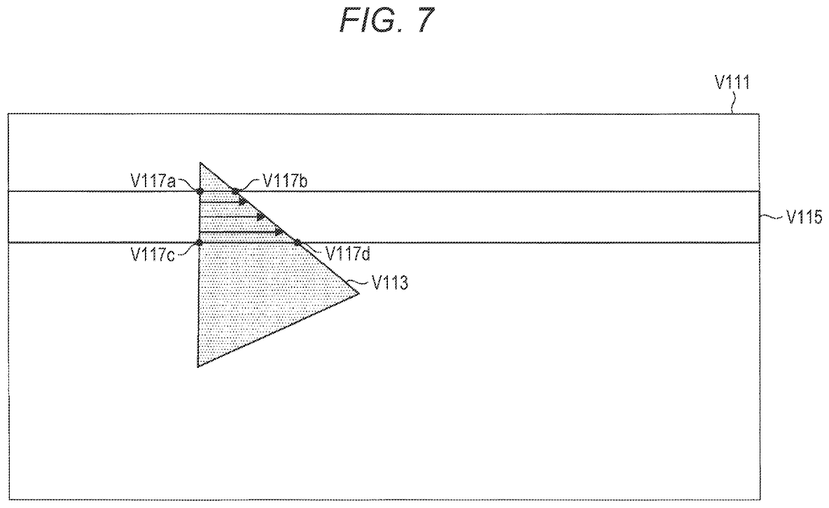

Next, an example of processing in which the information processing system according to the embodiment of the present disclosure draws a projection result of the object as two-dimensional display information will be described with reference to FIG. 7. FIG. 7 is an explanatory diagram for describing an outline of an example of processing of drawing an object having three-dimensional shape information as two-dimensional display information. Note that the processing illustrated in FIG. 7 can correspond to, for example, processing called “pixel shader”.

In FIG. 7, reference numeral V111 represents a drawing region in which the projection result of the object is drawn as two-dimensional display information. That is, the drawing region V111 is associated with at least a part of the screen surface illustrated in FIG. 6, and the projection result of the object onto the region is drawn as display information. Furthermore, the drawing region V111 is associated with a display region of an output unit such as a display, and a drawing result of the display information to the drawing region V111 can be presented in the display region. The drawing region V111 may be defined as at least a partial region of a predetermined buffer (for example, a frame buffer or the like) that temporarily or permanently holds data such as the drawing result. Furthermore, the display region itself may be used as the drawing region V111. In this case, the display information is directly drawn in the display region corresponding to the drawing region V111, so that the display information is presented in the display region. Furthermore, in this case, the display region itself can correspond to the screen surface (projection surface).

Furthermore, reference numeral V113 represents the projection result of the target object, that is, reference numeral V113 corresponds to the display information to be drawn. The drawing of the display information V113 is performed such that the drawing region V111 (in other words, the display region) is divided into a plurality of partial regions V115, and the drawing is performed for each partial region V115, for example. An example of the unit in which the partial region V115 is defined includes a unit region that is obtained by dividing the drawing region V111 to have a predetermined size, such as a scan line or a tile. For example, in the example illustrated in FIG. 7, the partial region V115 including one or more scan lines is defined, where a scan line is defined as a unit region.

Here, an outline of a flow of processing regarding drawing of the display information V113 for each partial region V115 will be described below.

In the information processing system according to the embodiment of the present disclosure, first, vertices of a portion of the display information V113, the portion corresponding to the target partial region V115, are extracted. For example, reference numerals V117a to V117d represent the vertices of the portion of the display information V113, the vertices corresponding to the partial region V115. In other words, in a case where the portion corresponding to the partial region V115 is cut out from the display information V113, the vertices of the cutout portion are extracted.

Next, the recognition result of the position and orientation of the viewpoint at an immediately preceding timing (for example, the latest recognition result) is acquired, and the positions of the vertices V117a to V117d are corrected according to the position and orientation of the viewpoint. More specifically, the target object is reprojected onto the partial region V115 according to the position and orientation of the viewpoint at the immediately preceding timing, and the positions of the vertices V117a to V117d (in other words, the shape of the portion of the display information V113, the portion corresponding to the partial region V115) are corrected according to a result of the reprojection. At this time, color information drawn as the portion corresponding to the partial region V115, of the display information V113, may be updated according to the result of the reprojection. Furthermore, a recognition timing of the position and orientation of the viewpoint used for the reprojection is more desirably a past timing closer to an execution timing of the processing regarding correction. As described above, the information processing system according to the present disclosure performs for each partial region V115, reprojection of the target object to the partial regions V115 according to the recognition results of the position and orientation of the viewpoint at different timings, and performs the correction according to the result of the reprojection. Note that, hereinafter, the processing regarding correction based on reprojection is also referred to as “reprojection shader”. Furthermore, the processing regarding reprojection of the object corresponds to an example of processing regarding projection of an object to a partial region.

Then, when the processing regarding correction based on reprojection is completed, the processing regarding drawing of the display information V113 according to the correction result in the target partial region V115 is executed. In the example illustrated in FIG. 7, the drawing of the display information V113 in the partial region V115 is sequentially executed for each scan line configuring the partial region V115, for example.

An outline of an example of the processing of drawing an object having three-dimensional shape information as two-dimensional display information in a situation where the object is presented to an output unit has been described with reference to FIGS. 6 and 7.

### 3.2. Basic Principle of Processing Regarding Drawing and Presentation of Display Information

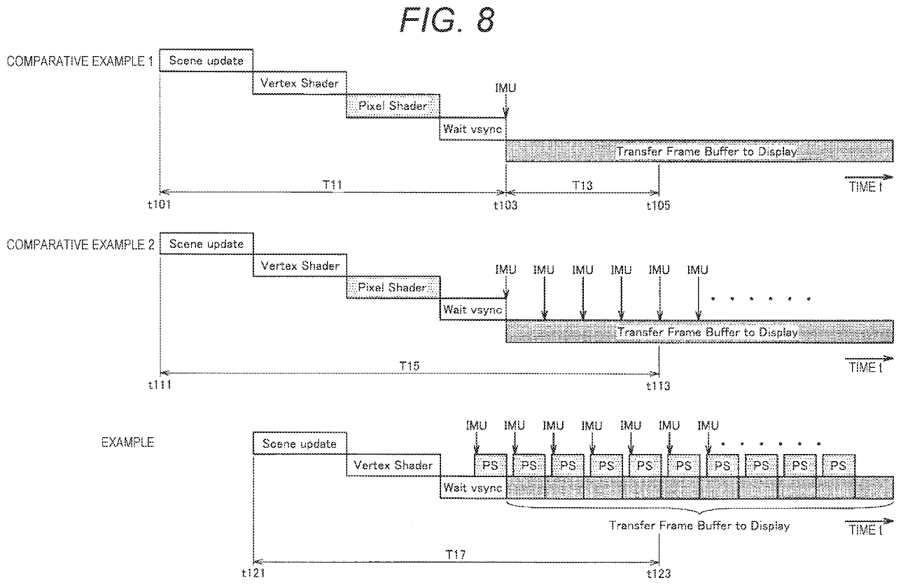

Next, a basic principle of processing of drawing an object as display information and presenting a result of the drawing in the information processing system according to the embodiment of the present disclosure will be described, particularly focusing on a timing when the recognition result of the position and orientation of the viewpoint is reflected. For example, FIG. 8 is an explanatory diagram for describing a basic principle of processing regarding drawing and presentation of display information in the information processing system according to an embodiment of the present disclosure. In FIG. 8, a timing chart illustrated as “Example” corresponds to an example of a timing chart of the processing of drawing an object as display information and presenting a result of the drawing in the information processing system according to the present embodiment. Note that FIG. 8 illustrates examples of timing charts of processing regarding drawing of an object applied in a conventional system as Comparative Examples 1 and 2 so that the characteristics of the information processing system according to the present embodiment can be more easily understood. Therefore, hereinafter, the characteristics of the information processing system according to the present embodiment will be described after an outline of each of Comparative Examples 1 and 2 is described. Note that the timing charts in FIG. 8 illustrate processing executed for each predetermined unit period regarding presentation of information such as a frame. Therefore, hereinafter, description will be given on the assumption that the processing regarding presentation of information is executed using one frame as the unit period, for convenience. However, the unit period regarding execution of the processing is not necessarily limited.

### Comparative Example 1

First, processing according to Comparative Example 1 will be described. The processing according to Comparative Example 1 corresponds to processing regarding drawing and presentation of display information in the case of two-dimensionally correcting the presentation position of the display information according to the position and orientation of the viewpoint, as in the example described with reference to FIG. 5.

For example, reference numeral t101 represents a start timing of processing regarding presentation of information for each frame in the processing according to Comparative Example 1. Specifically, at timing t101, first, information (for example, a scene graph) regarding a positional relationship between the viewpoint and an object to be drawn (for example, a virtual object) is updated (Scene Update), and the object is projected on the screen surface as two-dimensional display information according to a result of the update (Vertex Shader).

Then, when the processing regarding projection is completed, drawing of the display information according to a projection result of the object is executed in the frame buffer (Pixel Shader), and synchronization of processing regarding display of the display information in the display region of the output unit is waited (Wait vsync). For example, reference numeral t103 represents a timing when the processing regarding display of the display information in the display region of the output unit is started. As a more specific example, a timing of a vertical synchronization (Vsync) corresponds to an example of the timing t103.

In the processing according to Comparative Example 1, at the timing t103 when display of the display information in the display region is started, the presentation position of the display information in the display region is corrected on the basis of information regarding a recognition result of the position and orientation of the viewpoint obtained at an immediately preceding timing. A correction amount at this time is calculated such that a position among positions in the depth direction (z direction) (for example, a position of interest) can be consistent with a visually recognized position with the change in the position or orientation of the viewpoint For example, a timing illustrated by reference numeral IMU schematically represents a timing when the information according to the recognition result of the position or orientation of the viewpoint is acquired. Note that the information acquired at the timing may be favorably information according to the recognition result of the position and orientation of the viewpoint at a timing immediately before the timing, for example.

Then, when the correction of the presentation position of the display information in the display region is completed, drawing results of the display information held in the frame buffer are sequentially transferred to the output unit, and the display information is displayed in the display region of the output according to a result of the correction (Transfer FB to Display).

From the above characteristics, in the processing according to Comparative Example 1, the display information can be presented at a logically correct position regarding the position in the depth direction that is used as the reference for calculating the correction amount of the presentation position of the display information in a period T11 from the timing t101 to the timing t103. Meanwhile, even in the period T11, there are some cases where positions other than the position used as the reference for calculating the correction amount have a gap between the position at which the display information should be originally presented according to the position and orientation of the viewpoint and the position at which the display information is actually and visually recognized.

Furthermore, in a case where the viewpoint still moves at and after the timing t103, the presentation position of the display information in the display region associated with the field of view does not change even though the field of view changes with the movement of the viewpoint. Therefore, in this case, a gap occurs between the position at which the display information should be originally presented according to the position and orientation of the viewpoint after movement and the position at which the display information is actually and visually recognized regardless of the position in the depth direction, and this gap may become larger in proportion to an elapsed time from the timing t103 at which the correction has been performed.

For example, reference numeral t105 schematically represents an arbitrary timing during the period in which the drawing results of the display information are sequentially displayed in the display region of the output unit. As a specific example, the timing t105 may correspond to a timing when the display information is displayed on some scan lines. That is, in a period T13 between the timing t103 and the timing t105, the above-described gap of the presentation position of the display information becomes larger in proportion to the length of the period T13.

### Comparative Example 2

Next, processing according to Comparative Example 2 will be described. The processing according to Comparative Example 2 is different from the processing according to Comparative Example 1 in sequentially monitoring the position and orientation of the viewpoint, and correcting the presentation position of the display information to be sequentially displayed each time according to a monitoring result, even during execution of the processing of sequentially displaying the drawing results of the display information in the display region of the output unit (Transfer FB to Display). That is, as illustrated in FIG. 8, at each of timings illustrated with reference numerals IMU, the presentation position of the display information to be displayed in the display region at the each timing is corrected according to the recognition result of the position and orientation of the viewpoint acquired at the each timing. An example of the technology regarding the correction applied in the processing of Comparative Example 2 includes a technology called “raster correction”.

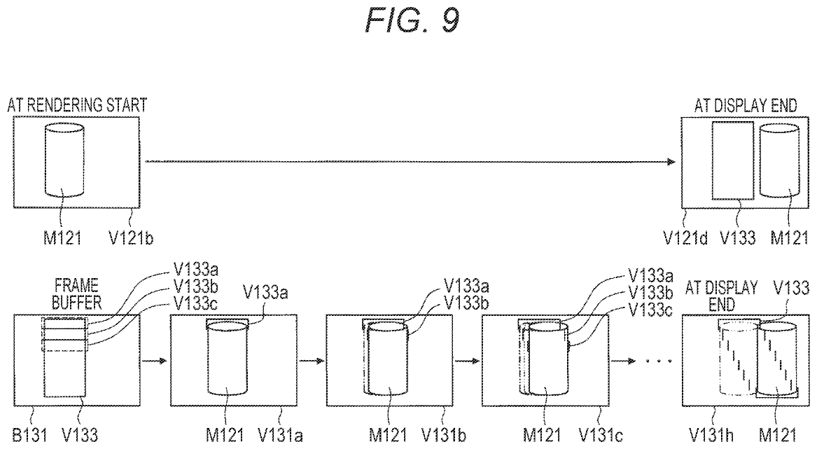

Here, an outline of processing according to Comparative Example 2 will be described giving a specific example with reference to FIG. 9. FIG. 9 is an explanatory diagram for describing an example of the processing regarding correction of the presentation position of the display information, and illustrates an example of the case of sequentially monitoring a change in the position and orientation of the viewpoint, and correcting the presentation position of display information V133 in the display region according to the monitoring result. Note that, in the example illustrated in FIG. 9, the case of presenting an image of a virtual object as the display information V133 to be superimposed on the real object M101 in the real space according to the position and orientation of the viewpoint P101 on the basis of the AR technology is assumed, similarly to the example described with reference to FIG. 5. Furthermore, in the example illustrated in FIG. 9, the position and orientation of the viewpoint P101 are assumed to further change in a series of flow where the display information V133 is rendered according to a recognition result of the position and orientation of the viewpoint P101, and then the display information V133 is displayed in the display region, similarly to the example described with reference to FIG. 5.

In FIG. 9, reference numeral V121b schematically represents a video within the field of view from the viewpoint P101 at the start of rendering the display information V133. Furthermore, reference numeral B131 schematically represents a frame buffer. That is, the display information V133 is drawn in the frame buffer B131 according to the previously acquired recognition result of the position and orientation of the viewpoint P101.

Each of reference numerals V133a to V133c schematically represents display information corresponding to a part of the display information V133. As a specific example, each of the display information V133a to V133c corresponds to a portion of the display information V133, the portion corresponding to each partial region, in the case of sequentially displaying the display information V133 for each partial region including one or more scan lines in the display region. Furthermore, each of reference numerals V131a, V131b, V131c, and V131h schematically represents a video in the field of view from the viewpoint P101 in each process from when the processing regarding display of the display information V133 in the display region is started to when the processing regarding display is completed. That is, the video in the field of view is sequentially updated as illustrated as the videos V131a, V131b, and V131c, by sequentially displaying the display information V133a, V133b, and V133c for each partial region in the display region. Furthermore, a video V131h corresponds to a video in the field of view at the timing when the display of the display information V133 is completed.

Furthermore, in the example illustrated in FIG. 9, a video in the field of view from the viewpoint P101 at the timing when display of the display information V133 is completed, in a case where correction is performed by a method similar to the case described with reference to FIG. 5, is illustrated as a video V121d, for comparison.

As illustrated in FIG. 9, in the processing according to Comparative Example 2, when a part of the display information V133, the part corresponding to a partial region, is displayed for the each partial region in the display region, the presentation position of the each part is corrected according to the acquired recognition result of the position and orientation of the viewpoint P101 acquired at an immediately preceding timing. That is, at a timing when display information V133a is displayed (in other words, a timing when a video V131a is displayed), the presentation position of the display information V133a in the display region is corrected according to the position and orientation of the viewpoint P101 acquired at an immediately preceding timing of the timing.

Specifically, in FIG. 8, reference numeral till represents a start timing of processing regarding presentation of information for each frame in the processing according to Comparative Example 2. Furthermore, reference numeral t113 schematically represents an arbitrary timing during the period in which the drawing results of the display information are sequentially displayed in the display region of the output unit, and corresponds to the timing t105 in the processing according to Comparative Example 1. According to the processing of Comparative Example 2, the display information can be presented at a logically correct position regarding the position in the depth direction that is used as the reference for calculating the correction amount of the presentation position of the display information in a period T15 from the timing till to the timing t113. That is, according to the processing of Comparative Example 2, a gap of the presentation position of the display information V133 with the movement of the viewpoint P101 can be suppressed, as compared with Comparative Example 1. Meanwhile, positions other than the position used as the reference for calculating the correction amount among the positions in the depth direction have the gap between the position at which the display information should be originally presented according to the position and orientation of the viewpoint and the position at which the display information is actually and visually recognized, even in the case where the processing according to Comparative Example 2 is applied.

### Example

Next, as processing according to Example, processing of drawing an object as display information and presenting a result of the drawing by the information processing system according to the embodiment of the present disclosure will be described. In FIG. 8, reference numeral t121 represents a start timing of processing regarding presentation of information for each frame in the processing according to Example. Furthermore, reference numeral t123 schematically represents an arbitrary timing during the period in which the drawing results of the display information are sequentially displayed in the display region of the output unit, and corresponds to the timing t105 in the processing according to Comparative Example 1 and the timing t113 in the processing according to Comparative Example 2. Furthermore, in FIG. 8, processing illustrated with reference numeral PS corresponds to the processing regarding drawing of the display information according to the projection result of the object (Pixel Shader) in the processing according to Comparative Example 1 and Comparative Example 2, and corresponds to the processing described with reference to FIG. 7 in the present example.

As described above with reference to FIG. 7, the information processing system according to the present embodiment divides the display region into a plurality of partial regions, and draws the display information for each partial region. At this time, the information processing system reprojects the target object in the partial region on the basis of the recognition result of the position and orientation of the viewpoint acquired at an immediately preceding timing (reprojection shader), and the result of the reprojection is reflected in the drawing of the display information in the partial region. That is, when the processing regarding drawing and presentation of the display information is executed for each partial region, the reprojection of the target object is performed each time according to the recognition result of the position and orientation of the viewpoint. For example, the timing illustrated by reference numeral IMU schematically represents the timing when the information according to the recognition result of the position and orientation of the viewpoint is acquired.

Specifically, at timing t121, first, information (for example, a scene graph) regarding the positional relationship between the viewpoint and the object to be drawn (for example, a virtual object) is updated (Scene Update), and the object is projected on the screen surface as two-dimensional display information according to a result of the update (Vertex Shader). Next, when the processing regarding projection is completed, synchronization regarding display of the display information in the display region of the output unit is performed (Wait vsync). Furthermore, the information processing system according to the present embodiment executes the processing regarding acquisition of the information regarding the recognition result of the position and orientation of the viewpoint, reprojection of the object according to the recognition result for each partial region, and drawing of the display information based on a result of the reprojection in the partial region (Pixel Shader) in parallel to the above processing.

Then, from a timing of a vertical synchronization (Vsync), the drawing result of the display information corresponding to the partial region is sequentially output to the output unit for each partial region, and the display information is displayed at the position corresponding to the partial region in the display region of the output unit (Transfer FB to Display). At this time, the processing regarding drawing of the display information based on the result of the reprojection in the partial region is executed in the back end in advance so that the drawing result of the display information can be acquired in accordance with a transfer timing of the display information for each partial region. That is, a timing when execution of the processing regarding reprojection is started, and a timing when the recognition result of the position and orientation of the viewpoint to be used for the processing regarding reprojection is acquired (in other words, a timing when the position and orientation of the viewpoint are recognized) can be determined according to the transfer timing of the display information (in other words, a presentation timing of the display information).

From such characteristics, the information processing system according to the present embodiment presents the display information at the logically correct position, for all the positions in the depth direction (z direction), when presenting the display information in each partial region. Specifically, in the example illustrated in FIG. 8, the display information is presented at the logically correct position, for all the positions in the depth direction (z direction), in a period T17 from the timing t121 to the timing t123, according to the processing of Example. As described above, the information processing system according to the present embodiment can present the information in a less logically broken mode than the processing according to Comparative Examples 1 and 2 even in the situation where the information is presented according to the position or orientation of the viewpoint.

A basic principle of the processing of drawing an object as display information and presenting a result of the drawing in the information processing system according to the embodiment of the present disclosure has been described with reference to FIG. 8, particularly focusing on the timing when the recognition result of the position and orientation of the viewpoint is reflected.

### 3.3. Functional Configuration

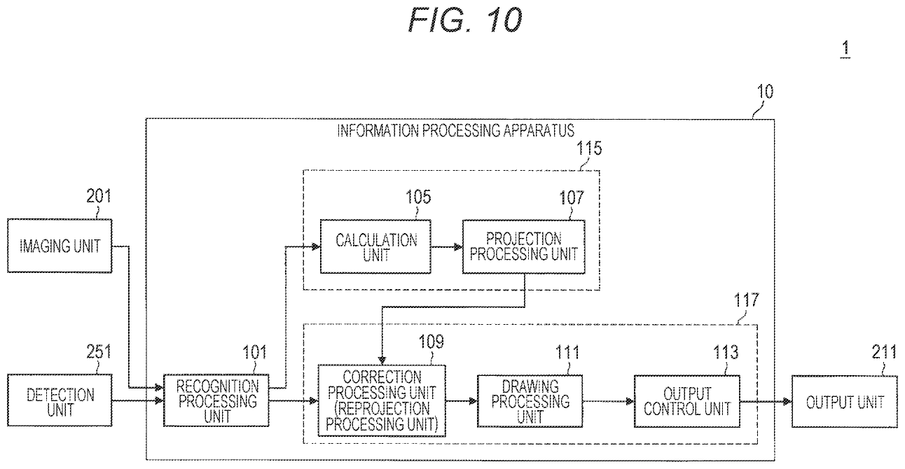

Next, an example of a functional configuration of the information processing system according to the embodiment of the present disclosure will be described, in particular, focusing on the configuration of the information processing apparatus 10 illustrated in FIG. 1. For example, FIG. 10 is a block diagram illustrating an example of a functional configuration of the information processing system according to the present embodiment.

As illustrated in FIG. 10, the information processing system 1 according to the present embodiment includes an imaging unit 201, a detection unit 251, the information processing apparatus 10, and an output unit 211. Note that the output unit 211 corresponds to, for example, the output unit 211 described with reference to FIG. 2.

The imaging unit 201 corresponds to the imaging units 201a and 201b configured as the stereo camera in FIG. 2. The imaging unit 201 captures an image of an object (subject) in the real space and outputs the captured image to the information processing apparatus 10.

The detection unit 251 schematically illustrates a portion regarding acquisition of information for detecting a change in the position or orientation of the input/output device 20 (and thus the movement of the head of the user wearing the input/output device 20). In other words, the detection unit 251 acquires information for detecting a change in the position or orientation of the viewpoint. As a specific example, the detection unit 251 may include various sensors such as an acceleration sensor and an angular velocity sensor. The detection unit 251 outputs the acquired information to the information processing apparatus 10. Thereby, the information processing apparatus 10 can recognize the change in the position or orientation of the input/output device 20.

Next, the configuration of the information processing apparatus 10 will be described. As illustrated in FIG. 10, the information processing apparatus 10 includes a recognition processing unit 101, a calculation unit 105, a projection processing unit 107, a correction processing unit 109, a drawing processing unit 111, and an output control unit 113.

The recognition processing unit 101 acquires the image captured by the imaging unit 201, and applies analysis processing to the acquired image, thereby recognizing the object (subject) in the real space captured in the image. As a specific example, the recognition processing unit 101 acquires images captured from a plurality of different viewpoints (hereinafter also referred to as “stereo images”) from the imaging unit 201 configured as a stereo camera, and measures the distance to the object captured in the image for each pixel of the image on the basis of the parallax between the acquired images. Thereby, the recognition processing unit 101 can estimate or recognize the relative positional relationship in the real space (in particular, the positional relationship in the depth direction) between the imaging unit 201 (and thus the input/output device 20) and each object captured in the image at the timing when the image is captured. The above is merely an example, and the method and the configuration therefor are not particularly limited as long as an object in the real space can be recognized. That is, the configuration of the imaging unit 201 and the like may be changed as appropriate according to the method of recognizing an object in the real space.

Furthermore, the recognition processing unit 101 may recognize the position or orientation of the viewpoint on the basis of the technology of self-position estimation, for example. As a specific example, the recognition processing unit 101 may perform self-position estimation and environment map creation on the basis of SLAM, thereby recognizing the positional relationship between the input/output device 20 (in other words, the viewpoint) and the object captured in the image in the real space. In this case, the recognition processing unit 101 may acquire information regarding the detection result of the change in the position and orientation of the input/output device 20 from the detection unit 251, and use the acquired information for the self-position estimation based on SLAM, for example. Note that the above is merely an example, and the method and the configuration therefor are not particularly limited as long as the position or orientation of the viewpoint can be recognized. That is, the configuration of the imaging unit 201, the detection unit 251, or the like may be changed as appropriate according to the method of recognizing the position or orientation of the viewpoint.

Then, the recognition processing unit 101 outputs information regarding the result of the self-position estimation of the input/output device 20 (that is, the recognition result of the position or orientation of the viewpoint) to the calculation unit 105 and the correction processing unit 109 to be described below. Note that the information regarding the result of self-position estimation, in other words, the information regarding the recognition result of at least one of the position or orientation of the viewpoint corresponds to an example of “first information”. Furthermore, the recognition processing unit 101 may recognize the position in the real space of each object (that is, the real object) captured in the image, and output information regarding the recognition result to the calculation unit 105. As a specific example, the recognition processing unit 101 may output information (that is, depth map) indicating the depth (the distance to the object) measured for each pixel in the image to the calculation unit 105. Note that information regarding the recognition result of the object (that is, the real object) in the real space corresponds to an example of the “second information”.

Note that the method of measuring the distance to the subject is not limited to the above-described measuring method based on a stereo image. Therefore, the configuration corresponding to the imaging unit 201 may be appropriately changed according to the distance measuring method. As a specific example, in the case of measuring the distance to the subject based on TOF, a light source for projecting an infrared light and a light-receiving element for detecting the infrared light projected from the light source and reflected at the subject may be provided instead of the imaging unit 201. Furthermore, when measuring the distance to the object, a plurality of measuring methods may be used. In this case, a configuration for acquiring information to be used for the measurement may be provided in the input/output device 20 or the information processing apparatus 10 according to the measuring method to be used. Of course, it goes without saying that the content of the information (for example, the depth map) indicating the recognition result of the position in the real space of each object captured in the image may be appropriately changed according to the applied measuring method.

The calculation unit 105 acquires the information regarding the result of the self-position estimation from the recognition processing unit 101, updates the position and orientation of the viewpoint on the basis of the acquired information, and updates the information regarding the positional relationship between the viewpoint (for example, rendering camera) and the object to be drawn (for example, virtual object) (Scene Update). Note that, hereinafter, the information regarding the positional relationship is referred to as a “scene graph”, for convenience. Furthermore, at this time, the calculation unit 105 may acquire the information regarding the recognition result of the object in the real space from the recognition processing unit 101, and update the scene graph in consideration of the position or orientation of the object in the real space on the basis of the acquired information. Then, the calculation unit 105 calculates the positions of the vertices that form the object to be drawn on the basis of an update result of the scene graph. Furthermore, at this time, the calculation unit 105 may specify information (for example, texture) of a surface of the object, for example. Then, the calculation unit 105 outputs information regarding the update result of the scene graph, in other words, the information regarding the position or orientation of the viewpoint and information regarding a three-dimensional position or orientation relationship between various objects including the object to be drawn and the viewpoint to the projection processing unit 107.

The projection processing unit 107 acquires the information regarding the update result of the scene graph according to the recognition result of the position or orientation of the viewpoint from the calculation unit 105. The projection processing unit 107 projects the object to be drawn on the screen surface defined according to the position or orientation of the viewpoint as two-dimensional display information on the basis of the acquired information. Thereby, for example, the vertices of the virtual object having three-dimensional information to be drawn are projected on the screen surface as two-dimensional information (Vertex Shader). Note that, when projecting the three-dimensional information on the screen surface as two-dimensional information, the projection processing unit 107 holds information in the depth direction (z direction) (for example, distance information) based on the three-dimensional information in association with the two-dimensional information projected on the screen surface. Then, the projection processing unit 107 outputs information regarding a projection result of the object on the screen surface based on the update result of the scene graph to the correction processing unit 109.

Note that processing by the processing block illustrated with reference numeral 115, that is, processing by the calculation unit 105 and the projection processing unit 107, of the configurations of the information processing apparatus 10 illustrated in FIG. 10, is executed before drawing of the display information for each frame is performed. That is, each processing executed by the processing block 115 is executed in frame units, for example. Note that each processing executed by the processing block 115 can correspond to an example of processing called rendering, for example. In contrast, processing by the processing block illustrated with reference numeral 117, that is, processing by the correction processing unit 109, the drawing processing unit 111, and the output control unit 113 to be described below is executed in presentation units of the display information to the output unit 211. As a specific example, in the case of dividing the display region of the output unit 211 into a plurality of partial regions, and executing various types of processing regarding presentation of the display information for each partial region, each processing executed by the processing block 117 is executed for each partial region. The processing by each of the correction processing unit 109, the drawing processing unit 111, and the output control unit 113 will be described below on the basis of the above description.

The correction processing unit 109 acquires the information regarding the result of the self-position estimation (that is, the recognition result of the position or orientation of the viewpoint) from the recognition processing unit 101 in time with the drawing timing of the display information for each partial region, and reprojects the target object to the partial region on the basis of the acquired information (reprojection shader). That is, the correction processing unit 109 can also be referred to as a “reprojection processing unit”. Here, an example of the processing regarding the reprojection by the correction processing unit 109 will be described in more detail below.

As described above, when the three-dimensional object is projected as the two-dimensional display information by the projection processing unit 107, the information in the depth direction (z direction) of the object is held in association with the display information. As a specific example, when three-dimensional coordinates of the vertices of the object are projected as two-dimensional coordinates, coordinate values in the depth direction (z direction) are also held. Here, in a case where the two-dimensional coordinates of a vertex after projection are U and V, and the coordinate in the depth direction is Z, a coordinate vector χ of the vertex in a homogeneous coordinate system can be expressed by the calculation formula shown as (Expression 1) below.

[Math. 1]

χ=[U V Z⁻¹ 1]^{T} (Expression 1)

The correction processing unit 109 calculates the change in the position or orientation of the viewpoint (in other words, the input/output device 20) from the execution of the processing regarding projection by the projection processing unit 107 (Vertex Shader) on the basis of the result of the self-position estimation acquired at an immediately preceding timing (that is, the latest result of the self-position estimation). At this time, the correction processing unit 109 may calculate, for example, a rotation change amount R and a position change amount T as changes in the position and orientation of the viewpoint. The rotation change amount R is represented as, for example, a three-dimensional vector having information of rotation angles (rad) of a roll axis, a pitch axis, and a yaw axis. Furthermore, the position change amount T is represented as a three-dimensional vector having information of moving amounts (m) along axes in a right-left direction, an up-down direction, and the depth direction as viewed from the viewpoint. Note that, in the following description, for convenience, the axes corresponding to the right-left direction, the up-down direction, and the depth direction as viewed from the viewpoint are also referred to as “x axis”, “y axis”, and “z axis”, respectively.

The correction processing unit 109 calculates the moving amounts of the vertices of the target object on the two-dimensional coordinates after projection onto the screen surface on the basis of the calculation result of the change amounts in the position and orientation of the viewpoint. At this time, if the rotation amount of the viewpoint is small, a matrix ΔT representing the change in the viewpoint is expressed by a matrix illustrated as (Expression 2) below.

$$\begin{matrix}[ Math . 2 ] & \\ Δ T = [ \begin{matrix}1 & - {R}_{z} & {R}_{y} & {T}_{x} \\ {R}_{z} & 1 & - {R}_{x} & {T}_{y} \\ - {R}_{y} & {R}_{x} & 1 & {T}_{z} \\ 0 & 0 & 0 & 1\end{matrix} ] & ( Expression 2 )\end{matrix}$$

In Expression 2 above, Tₓ, T_{y}, and T_{z} represent an x-axis component, a y-axis component, and a z-axis component of the above-described position change amount T, respectively. Furthermore, Rₓ, R_{y}, and R_{z} represent an angle component of rotation around the x axis (a pitch-axis component), an angle component of rotation around the y axis (a yaw-axis component), and a rotation angle component around the z axis (a roll-axis component) among the components of the rotation change amount R, respectively.

Furthermore, a projection matrix of the display (output unit 211) is a matrix P expressed as (Expression 3) below.

$$\begin{matrix}[ Math . 3 ] & \\ P = [ \begin{matrix}{f}_{x} & 0 & {c}_{y} & 0 \\ 0 & {f}_{y} & {c}_{x} & 0 \\ 0 & 0 & 0 & 1 \\ 0 & 0 & 1 & 0\end{matrix} ] & ( Expression 3 )\end{matrix}$$

In Expression 3 above, cₓ and c_{y} correspond to a center of the two-dimensional coordinate system, that is, an image center of the display. Furthermore, fₓ and f_{y} represent focal lengths in the x-axis direction and the y-axis direction in the two-dimensional coordinate system, respectively.

In the case of reprojecting a vertex of the target object on the basis of the above description, coordinates of the vertex after reprojection in the two-dimensional coordinate system is expressed by P·ΔT·P⁻¹·χ. Note that, since the coordinate vector χ of the vertex is in the homogeneous coordinate system, as described above, division of the homogeneous coordinate system by a w component may be required when calculating the coordinate of the vertex after reprojection. Furthermore, since P·ΔT·P⁻¹ is a constant component for each model, it may be calculated in advance for each model, for example.

By the above processing, the correction processing unit 109 can acquire the information regarding the result of the self-position estimation (that is, the recognition result of the position or orientation of the viewpoint) from the recognition processing unit 101 in time with the drawing timing of the display information for each partial region, and reproject the target object to the partial region on the basis of the acquired information.

Note that it is desirable that the processing regarding reprojection of the object for each partial region by the correction processing unit 109 is completed by the timing when the drawing processing unit 111 to be described below starts the drawing in the partial region. Therefore, the timing when the correction processing unit 109 starts the processing regarding reprojection for each partial region, and the result of the self-position estimation acquired at which timing (in other words, the position or orientation of the viewpoint recognized at which timing) is used at the reprojection may be appropriately designed according to the time required for the processing regarding reprojection. Furthermore, in the case where completion of the processing regarding reprojection for a partial region is difficult by the timing when drawing of the display information in the partial region is started, the correction processing unit 109 may skip the processing regarding reprojection to the partial region.

Furthermore, the above description is merely an example, and the projection method is not particularly limited as long as the correction processing unit 109 can reproject the target object to the partial region according to the recognition result of the position or orientation of the viewpoint acquired at a desired timing for each partial region.

Then, the correction processing unit 109 outputs information regarding the reprojection result of the target object to the target partial region to the drawing processing unit 111 located in a subsequent stage.

The drawing processing unit 111 acquires, in time with the drawing timing of the display information for each partial region, the information regarding the reprojection result of the target object to the partial region from the correction processing unit 109. The drawing processing unit 111 draws the display information (two-dimensional display information) according to the reprojection result of the object to the partial region in the frame buffer on the basis of the acquired information. The processing regarding drawing may correspond to, for example, processing called rasterization.

The output control unit 113 sequentially transfers a drawing result of the display information for each partial region in the frame buffer by the drawing processing unit 111 to the output unit 211. At this time, the output control unit 113 may two-dimensionally correct the presentation position of the display information in the partial region on the basis of the information regarding the recognition result of the position or orientation of the viewpoint, which is acquired at an immediately preceding timing. As a specific example, in the case where the correction processing unit 109 cannot reflect the immediately preceding recognition result of the position or orientation of the viewpoint in some display information (for example, in the case where the processing regarding reprojection is skipped), the output control unit 113 may two-dimensionally correct the presentation position of the display information in the corresponding partial region

As described above, the display information based on the projection result of the target object according to the position or orientation of the viewpoint of the time is sequentially presented to the display region of the output unit 211 for each partial region. With the above configuration, the information processing system according to the embodiment of the present disclosure can present the display information according to the position or orientation of the viewpoint in a less logically broken mode even in the situation where the position or orientation of the viewpoint may sequentially change.

Note that the functional configurations of the information processing system 1 illustrated in FIG. 10 are mere examples, and the functional configurations of the information processing system 1 are not necessarily limited to the example illustrated in FIG. 10 as long as the operation of the above-described configurations can be implemented. As a specific example, at least one of the imaging unit 201, the detection unit 251, or the output unit 211 may be integrally configured with the information processing apparatus 10. Furthermore, as another example, some functions of the information processing apparatus 10 may be provided outside the information processing apparatus 10. As a specific example, the portion corresponding to the recognition processing unit 101 and the processing block 115 may be provided outside the information processing apparatus 10. Furthermore, at least some functions of the information processing apparatus 10 may be implemented by a plurality of devices operating in cooperation with one another.

Note that the portion corresponding to the processing blocks 115 and 117 (in particular, the portion corresponding to the processing block 117), of the configurations of the information processing apparatus 10, correspond to an example of a “control unit”. Furthermore, the portion that acquires the information regarding the result of self-position estimation, in other words, the information regarding the recognition result of at least one of the position or orientation of the viewpoint from the recognition processing unit 101, of the processing blocks 115 and 117, corresponds to an example of an “acquisition unit”.

Furthermore, partial regions different from each other, of the plurality of partial regions obtained by dividing the display region, correspond to an example of a “first partial region” and a “second partial region”. Furthermore, the timing when the position or orientation of the viewpoint used for reprojecting the target object to the first partial region is recognized (or the timing when the recognition result of the position or orientation of the viewpoint is acquired) corresponds to an example of “first timing”. Furthermore, the series of processing executed by the processing block 117 (that is, the correction processing unit 109, the drawing processing unit 111, and the output control unit 113) for the first partial region corresponds to an example of “first processing”. Similarly, the timing when the position or orientation of the viewpoint used for reprojecting the target object to the second partial region is recognized (or the timing when the recognition result of the position or orientation of the viewpoint is acquired) corresponds to an example of “second timing”. Furthermore, the series of processes executed by the process block 117 for the second partial region corresponds to an example of “second processing”. Note that, in a case where the processing for the plurality of partial regions is sequentially executed in predetermined order, for each predetermined unit period such as frame, the first processing and the second processing are also executed in predetermined order. With the execution, the relationship between the first timing and the second timing can also be determined according to the order in which the first processing and the second processing are executed. That is, in the case where the second processing is executed after the first processing is executed, the second timing can be a later timing of the first timing.

As described above, an example of the functional configuration of the information processing system according to the embodiment of the present disclosure has been described with reference to FIG. 10, in particular, focusing on the configuration of the information processing apparatus 10 illustrated in FIG. 1.

### 3.4. Processing

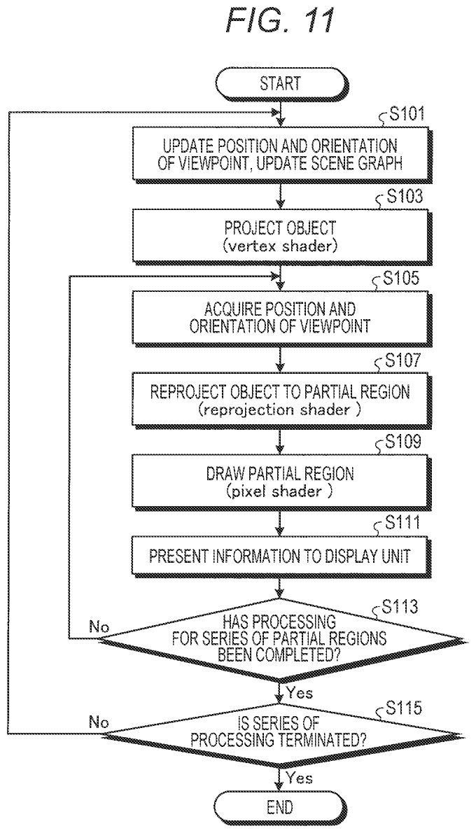

Next, an example of a flow of series of processing of the information processing system according to the embodiment of the present disclosure will be described, in particular, focusing on the operation of the information processing apparatus 10 illustrated in FIG. 1. For example, FIG. 11 is a flowchart illustrating an example of a flow of a series of processing of the information processing system according to the embodiment of the present disclosure.

As illustrated in FIG. 11, the information processing apparatus 10 (recognition processing unit 101) recognizes at least one of the position or orientation of the viewpoint on the basis of the information regarding the imaging result of the image by the imaging unit 201 and the detection result of the change in the position or orientation of the input/output device 20 by the detection unit 251. A self-position estimation technology such as SLAM may be used for the recognition of the position or orientation of the viewpoint, for example. As described above, the information processing apparatus 10 sequentially update the recognition result of the position or orientation of the viewpoint on the basis of the above-described various types of information acquired at each time. Furthermore, the information processing apparatus 10 (calculation unit 105) updates the information regarding the positional relationship between the viewpoint and the object to be drawn (that is, the scene graph) on the basis of the information regarding the recognition result of the position or orientation of the viewpoint (for example, the information according to the result of the self-position estimation) (S101).

The information processing apparatus 10 (projection processing unit 107) projects the object to be drawn on the screen surface defined according to the position or orientation of the viewpoint as two-dimensional display information on the basis of the update result of the scene graph (S103). Thereby, for example, the vertices of the virtual object having three-dimensional information to be drawn are projected on the screen surface as two-dimensional information.

The information processing apparatus 10 (correction processing unit 109) acquires the information regarding the result of the self-position estimation (that is, the recognition result of the position or orientation of the viewpoint) from the recognition processing unit 101 in time with the drawing timing of the display information for each partial region (S105) and reprojects the target object to the partial region on the basis of the acquired information (S107).

The information processing apparatus 10 (drawing processing unit 111) draws, in time with the drawing timing of the display information for each partial region, the display information (two-dimensional display information) according to the reprojection result of the target object to the partial region in the frame buffer (S109).

The information processing apparatus 10 (output control unit 113) sequentially transfers the drawing result of the display information for each partial region in the frame buffer to the output unit 211, thereby displaying the display information in the partial region of the display region of the output unit 211 (S111).

As described above, the information processing apparatus 10 sequentially executes the series of processing described as reference numerals S105 to S111 for each of the series of partial regions, which are obtained by dividing the display region (S113, NO). Thereby, the display information based on the projection result of the target object according to the position or orientation of the viewpoint of the time is sequentially presented to the display region of the output unit 211 for each partial region. Then, with the completion of the processing for each of the series of partial regions (S113, YES), the processing regarding presentation of the display information to the output unit 211 according to the position or orientation of the viewpoint, which is executed by the information processing apparatus 10 in frame units, is completed.

The information processing apparatus 10 sequentially executes the series of processing described as reference numerals S101 to S113 in frame units until an instruction of termination of execution of the series of processing is given (S115, NO). Then, when receiving the instruction of termination of execution of the series of processing (S115, YES), the information processing apparatus 10 terminates the execution of the series of processing illustrated with reference numerals S101 to S113.

An example of the flow of the series of processing of the information processing system according to the embodiment of the present disclosure has been described with reference to FIG. 11, in particular, focusing on the operation of the information processing apparatus 10 illustrated in FIG. 1.

### 3.5. Modification

Next, modifications of the information processing system according to the embodiment of the present disclosure will be described.

(Control Example According to Relationship Between Processing Load and Presentation Timing Regarding Presentation of Information)

The information processing system according to the present embodiment needs to perform, for each partial region, reprojection of the object (reprojection shader), drawing of the display information according to the result of reprojection (Pixel Shader), and transfer of the display information to the output unit (Transfer FB to display), as described with reference to FIG. 8. Therefore, in a case where the time required for these series of processing exceeds the period in which the information is presented to each partial region, a possibility that completion of execution of the series of processing cannot be in time for the presentation timing of the display information to the corresponding partial region may be assumed. Therefore, in such a case, the processing regarding reprojection and drawing may be skipped for some partial regions.

Note that, in the case where the processing regarding reprojection and drawing is skipped for some partial regions, for example, alternative display information may be presented instead of the display information according to the results of the reprojection and drawing, which are originally scheduled to be presented to the partial regions. In this case, the alternative display information may be drawn in advance in the frame buffer. Furthermore, as the alternative display information, for example, information of the color of the surface of the target object (that is, the color not considering the position and orientation of the viewpoint, the position of the light source, and the like) may be used.

Furthermore, as another example, whether or not the completion of the series of processing can be in time for the presentation timing of the information to the corresponding partial region is determined by estimating the processing time required for the above-described series of processing in advance, and processing corresponding to the partial region may be selectively switched according to a result of the determination. As a specific example, in the case where it is determined that it is difficult to complete the series of processing in time for the presentation timing of the information to the corresponding partial region on the basis of a result of the estimation, drawing of the display information in the partial region may be started without waiting for acquisition of the recognition result of the position or orientation. Note that, in this case, the presentation position of the display information may be two-dimensionally corrected according to the recognition result of the position or orientation of the viewpoint acquired immediately before the presentation timing of the display information, for example. Note that, for the above estimation, information such as the drawing amount of the display information for the target partial region, the time required for the target partial region in the previous frame, and the like can be used, for example.

Furthermore, there are a type in which a pixel continues to emit light and a type in which the pixel turns off (that is, becomes a black image) after the pixel emits light, depending on the type of the output unit (display) or the like. The information drawn in the frame buffer in the immediately preceding frame may be held in order to implement a similar output regardless of such a difference in the specifications of the output unit.

(Measures Against Distortion of Display Information)

As described above, the information processing system according to the present embodiment reprojects the object for each partial region. Therefore, when the moving amount of the viewpoint during execution of the series of processing regarding presentation of information for each partial region increases, pieces of the display information presented to adjacent partial regions may become discontinuous. In such a case, the display information presented to at least part of the partial regions may be corrected so that the pieces of display information respectively presented to the adjacent partial regions are presented as a series of continuous display information. As a specific example, by adjusting the position of the vertex of the display information presented to at least part of the adjacent partial regions, the pieces of display information respectively presented to the adjacent partial regions can be caused to be presented as a series of continuous display information.

(Control Example of Rendering Quality)

In the case of presenting an object having three-dimensional information as two-dimensional display information by rendering as in the information processing system according to the present embodiment, a situation where a processing load of the rendering becomes larger can be assumed. Meanwhile, the processing load associated with execution of the rendering may change according to the quality of the rendering. Therefore, the load of processing regarding presentation of information based on the rendering may be reduced by controlling the quality of the rendering according to various situations.

As a specific example, the processing load may be reduced by degrading the quality of the rendering for portions other than a portion of interest (in other words, a portion viewed from the viewpoint) in the field of view according to the position or orientation of the viewpoint. An effect of further reducing power consumption is expected by further reduction of the processing load with such control, for example.

Furthermore, as another example, in a situation where so-called “movement blur” occurs, such as a situation where the viewpoint moves at high speed, a high-quality image (for example, an image rendered at a higher resolution) is not always required. Therefore, in such a case, the processing load may be reduced by degrading the rendering quality.

(Control Example According to Drawing Frame Rate)

The frame rate of the processing regarding reprojection of the object (that is, the processing regarding correction) and the frame rate of the processing regarding drawing according to the result of the reprojection do not necessarily need to match. Specifically, it is desirable to maintain the state where the frame rate of the processing regarding reprojection is equal to or higher than the frame rate of the processing regarding drawing, and if the condition is satisfied, the frame rates do not need to match. Therefore, for example, even in a case where the frame rate of the processing regarding drawing is reduced to 30 fps from a state where the frame rates of the processing regarding reprojection and the processing regarding drawing are 60 fps, the frame rate of the processing regarding reprojection is favorably maintained to 60 fps. That is, even if the frame rate regarding presentation of the display information (first frame rate) is reduced, the frame rate regarding projection to any partial region (the second frame rate) may be set to be larger than the first frame rate. Note that the processing block 117 can perform the control, for example.

(Control Example Assuming Hidden Surface)

In the situation where the viewpoint moves, a case where a surface not visible before the movement of the viewpoint becomes visible with the movement of the viewpoint can be assumed. Therefore, for example, in the processing regarding projection of an object on the screen surface (Vertex Shader), which is executed before the processing regarding presentation of information to each partial region is started, information that can be used for presentation of display information (for example, information of vertices and the like) may be calculated in advance for at least some of surfaces (hidden surfaces) that are difficult to see from the position of the viewpoint at that time. As a specific example, the information that can be used for presentation of display information may be calculated for a hidden surface that may be viewed when the viewpoint moves within an assumed range of moving amount with the position or orientation of the viewpoint before movement as starting point.

(Control Example of Texture Fetch)

In the case of presenting an object having three-dimensional information as two-dimensional display information as in the information processing system according to the present embodiment, a situation where it is difficult to make fetch of a texture in time for the presentation timing of the display information can be assumed. In such a case, for example, a texture for mipmap (especially, a texture with a relatively small size) is held in advance, and in a case where it is predicted that fetch of a texture cannot be in time, the texture for mipmap may be used for display of the display information. Furthermore, in a case where the order of pixel values to be used in a texture can be predicted in advance, the pixel values may be cached in advance according to a result of the prediction.

(Control Example of Refresh Rate of Display)

In the case of presenting an object having three-dimensional information as two-dimensional display information by rendering as in the information processing system according to the present embodiment, a frame rate of the rendering and a refresh rate of a display may be different. In particular, with the recent improvement of the refresh rate of a display, a situation in which the refresh rate of a display becomes higher than the frame rate of rendering can be assumed. In such a case, the information processing system according to the present embodiment can implement processing in consideration of the difference between the rates when executing the processing regarding reprojection for each partial region.

Specifically, it is favorable to give a velocity term (that is, information about a moving velocity of a vertex) to each vertex of the object and to reflect the velocity information when performing reprojection of the object to each partial region. Note that the velocity term can be calculated on the basis of, for example, the velocity of a virtual object itself or the velocity of change in the position or orientation of the viewpoint. More specifically, in the case where the frame rate of rendering is lower than the refresh rate of a display, a timing occurs in which the latest information of the position or orientation of the viewpoint is not reflected when presenting information to the display. Even in such a case, the information processing system according to the present embodiment can reproduce a change in the presentation position of information according to the change in the position or orientation of the viewpoint in a pseudo manner by performing reprojection in consideration of the moving amount of the vertex according to the velocity term of each vertex.

With the above control, even in the case where the refresh rate of a display is 120 Hz whereas the frame rate of rendering is 30 Hz, for example, an animation at the frame rate of 120 Hz (that is, four times the frame rate of rendering) can be reproduced in a pseudo manner.

(Application to Ray Tracing)

The information processing system according to the present embodiment reprojects a target object according to the position or orientation of the viewpoint in time with the presentation timing of information for each partial region, and draws the display information on the basis of the result of the reproduction, as described above. Some processing of the series of processing of the information processing system can be appropriately changed as long as the some processing does not deviate from the basic principle of the processing regarding drawing and presentation of display information by the information processing system according to the present embodiment.

As a specific example, a technology called ray tracing cam be applied to the processing corresponding to rendering, of the series of processing by the information processing system according to the present embodiment. In this case, processing regarding ray tracing executed for each pixel can correspond to the processing regarding projection and reprojection, that is, the processing of projecting an object having three-dimensional shape information as two-dimensional display information (Vertex Shader) and the processing of reprojecting an object (reprojection shader).

As a more specific example, in the case of performing reprojection to each partial region, the position of a camera (rendering camera), which is a base point of the processing regarding ray tracing, may be determined according to the position or orientation of the viewpoint acquired at an immediately preceding timing.

The modifications of the information processing system according to the embodiment of the present disclosure have been described.

### 3.6. Example

Next, as an example of the embodiment of the present disclosure, an example of a presentation mode of the display information by the information processing system 1 according to the present embodiment in the case where the position or orientation of the viewpoint has changed with movement of the viewpoint will be described giving a specific example.

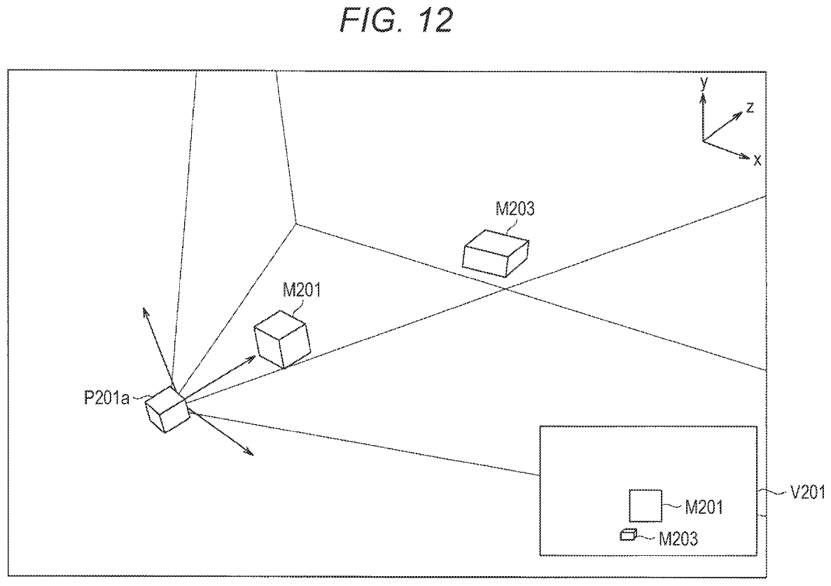

For example, FIG. 12 is an explanatory diagram for describing an outline of an example of the information processing system according to the present embodiment, and schematically illustrates a state before the viewpoint moves. In FIG. 12, reference numeral P201a schematically represents the position and orientation of the viewpoint, and as a specific example, corresponds to the position and orientation of the input/output device 20 (more strictly, the imaging unit 201) in the example illustrated in FIG. 1. Furthermore, reference numerals M201 and M203 schematically represent objects (for example, virtual objects) to be drawn as the display information.

In the example illustrated in FIG. 12, a video within the field of view from the viewpoint P201a is presented on the basis of the above assumptions. Specifically, the objects M201 and M203 are projected on the screen surface according to the position and orientation of the viewpoint P201a as two-dimensional display information, according to the position and orientation relationship between the viewpoint P201a and the objects M201 and M203. For example, reference numeral V201 schematically represents a video corresponding to the field of view from the viewpoint P201a, which is presented according to the recognition result of the position and orientation of the viewpoint P201a (in other words, the result of the self-position estimation) in the example illustrated in FIG. 12. Note that, in the example illustrated in FIG. 12, the viewpoint P201a faces the front surface of the object M201, and it can be seen that surfaces other than the front surface are not presented for the object M201 in the video V201.

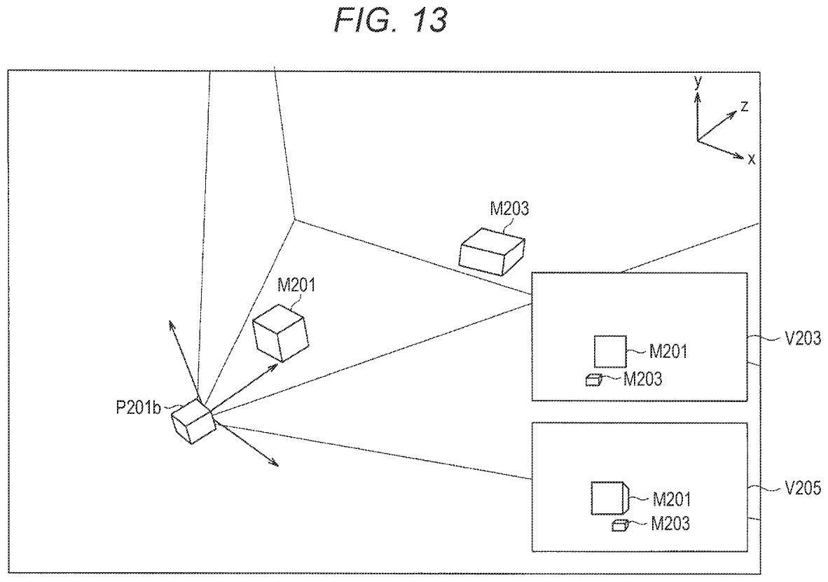

Furthermore, FIG. 13 is an explanatory diagram for describing an outline of an example of the information processing system according to the present embodiment, and schematically illustrates a state after the viewpoint has moved. In FIG. 13, reference numeral P201b schematically represents the position and orientation of the viewpoint after the viewpoint has moved from the state illustrated in FIG. 12. Note that, in the following description, the viewpoint P201a before movement illustrated in FIG. 12 and the viewpoint P201b after movement illustrated in FIG. 13 may be simply referred to as “viewpoint P201” unless otherwise distinguished. Furthermore, reference numerals M201 and M203 correspond to the objects M201 and M203 illustrated in FIG. 12.

Furthermore, reference numeral V205 schematically represents a video corresponding to the field of view from the viewpoint P201 (that is, the viewpoint P201b after movement) presented with the movement of the viewpoint P201 by the information processing system 1 according to the embodiment of the present disclosure. As illustrated in FIG. 13, a side surface of the object M201, which was not visible from the viewpoint P201a before movement, is visible from the position of the viewpoint P201b after movement. Therefore, in the video V205, since the two-dimensional display information corresponding to the object M201 is presented on the basis of the processing regarding reprojection according to the position and orientation of the viewpoint P201b after movement, the side surface of the object M201 is visually presented. Furthermore, the display information corresponding to each of the objects M201 and M203 is presented on the basis of the positional relationship considering the position and orientation of the viewpoint P201b after movement.

In contrast, reference numeral V203 represents an example of a case where the presentation positions of the two-dimensional display information at which the objects M201 and M203 are projected before movement of the viewpoint P201 is two-dimensionally corrected with the movement of the viewpoint P201, as described with reference to FIG. 5. As illustrated in FIG. 13, in the video V203, the presentation positions of the display information corresponding to the objects M201 and M203 presented as the video V201 illustrated in FIG. 12 are two-dimensionally corrected according to the change in the position or orientation of the viewpoint P201. Therefore, the side surface of the object M201 is not presented in the video V203 although the side surface of the object M201 is visible from the viewpoint P201b after movement. Furthermore, it can be seen that the positional relationship of the pieces of display information respectively corresponding to the objects M201 and M203 is not the positional relationship as viewed from the viewpoint P201b after movement.

As described above, the information processing system 1 according to the embodiment of the present disclosure can present the two-dimensional display information in which the target object is projected in a less logically broken mode even in the situation where the information is presented according to the position or orientation of the viewpoint.

As an example of the embodiment of the present disclosure, an example of the presentation mode of the display information by the information processing system 1 according to the present embodiment in the case where the position or orientation of the viewpoint has changed with movement of the viewpoint has been described giving a specific example, with reference to FIGS. 12 and 13.

### 4. Hardware Configuration

Next, an example of a hardware configuration of the information processing apparatus 10 that configures the information processing system according to the present embodiment will be described.

(Configuration Example as Independently Operable Device)

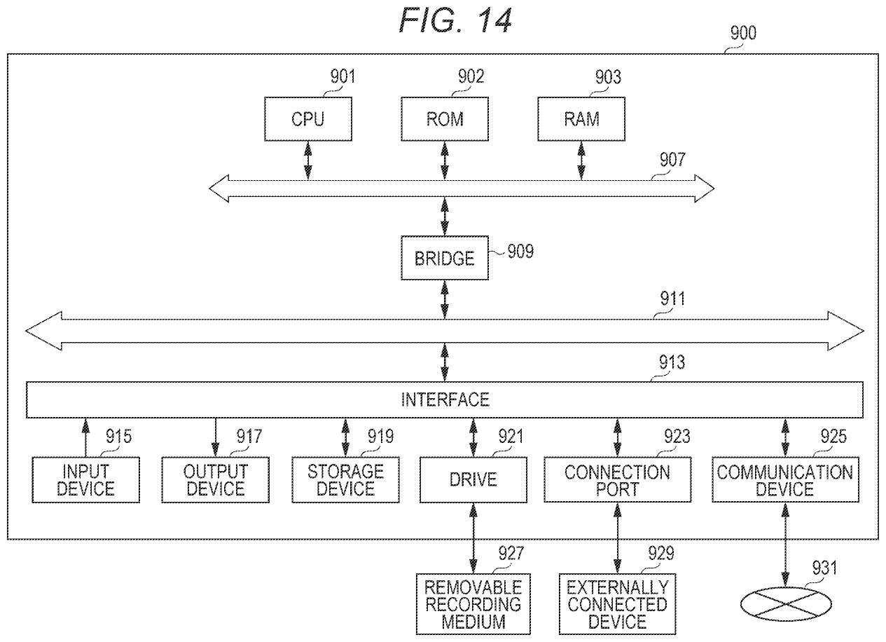

First, an example of a hardware configuration of an information processing apparatus 900 in a case where the configuration corresponding to the above-described information processing apparatus 10 is implemented as an independently operable device such as a PC, a smartphone, or a server (which will be referred to as the “information processing apparatus 900” for convenience) will be described in detail with reference to FIG. 14. FIG. 14 is a functional block diagram illustrating an example of a hardware configuration of the information processing apparatus 900 configuring the information processing system according to the embodiment of the present disclosure.

The information processing apparatus 900 configuring the information processing system 1 according to the present embodiment mainly includes a CPU 901, a ROM 902, and a RAM 903. Furthermore, the information processing apparatus 900 further includes a host bus 907, a bridge 909, an external bus 911, an interface 913, an input device 915, an output device 917, a storage device 919, a drive 921, a connection port 923, and a communication device 925.

The CPU 901 functions as an arithmetic processing unit and a control device, and controls general operation or part thereof of the information processing apparatus 900 according to various programs recorded in the ROM 902, the RAM 903, the storage device 919, or a removable recording medium 927. The ROM 902 stores programs, arithmetic operation parameters, and the like used by the CPU 901. The RAM 903 primarily stores the programs used by the CPU 901, parameters that appropriately change in execution of the programs, and the like. The CPU 901, the ROM 902, and the RAM 903 are mutually connected by the host bus 907 configured by an internal bus such as a CPU bus. Note that the recognition processing unit 101, the calculation unit 105, the projection processing unit 107, the correction processing unit 109, the drawing processing unit 111, and the output control unit 113, which have been described with reference to FIG. 10, can be implemented by, for example, the CPU 901.

The host bus 907 is connected to the external bus 911 such as a peripheral component interconnect/interface (PCI) bus via the bridge 909. Furthermore, the input device 915, the output device 917, the storage device 919, the drive 921, the connection port 923, and the communication device 925 are connected to the external bus 911 via the interface 913.

The input device 915 is an operation unit operated by the user, such as a mouse, a keyboard, a touch panel, a button, a switch, a lever, and a pedal, for example. Furthermore, the input device 915 may be, for example, a remote control unit (so-called remote controller) using infrared rays or other radio waves or an externally connected device 929 such as a mobile phone or a PDA corresponding to an operation of the information processing apparatus 900. Moreover, the input device 915 is configured by, for example, an input control circuit for generating an input signal on the basis of information input by the user using the above-described operation unit and outputting the input signal to the CPU 901, or the like. The user of the information processing apparatus 900 can input various data and give an instruction on processing operations to the information processing apparatus 900 by operating the input device 915.

The output device 917 is configured by a device that can visually or audibly notify the user of acquired information. Examples of such devices include display devices such as a CRT display device, a liquid crystal display device, a plasma display device, an EL display device, a lamp, and the like, sound output devices such as a speaker and a headphone, and a printer device. The output device 917 outputs, for example, results obtained by various types of processing performed by the information processing apparatus 900. Specifically, the display device displays the results of the various types of processing performed by the information processing apparatus 900 as texts or images. Meanwhile, the sound output device converts an audio signal including reproduced sound data, voice data, or the like into an analog signal and outputs the analog signal. Note that the output unit 211 described with reference to FIG. 10 can be implemented by the output device 917, for example.

The storage device 919 is a device for data storage configured as an example of a storage unit of the information processing apparatus 900. The storage device 919 is configured by a magnetic storage device such as a hard disk drive (HDD), a semiconductor storage device, an optical storage device, a magneto-optical storage device, or the like, for example. The storage device 919 stores programs executed by the CPU 901, various data, and the like.

The drive 921 is a reader/writer for a recording medium, and is built in or is externally attached to the information processing apparatus 900. The drive 921 reads out information recorded on the removable recording medium 927 such as a mounted magnetic disk, optical disk, magneto-optical disk, or semiconductor memory, and outputs the information to the RAM 903. Furthermore, the drive 921 can also write a record on the removable recording medium 927 such as the mounted magnetic disk, optical disk, magneto-optical disk, or semiconductor memory. The removable recording medium 927 is, for example, a DVD medium, an HD-DVD medium, a Blu-ray (registered trademark) medium, or the like. Furthermore, the removable recording medium 927 may be a compact flash (CF (registered trademark)), a flash memory, a secure digital (SD) memory card, or the like. Furthermore, the removable recording medium 927 may be, for example, an integrated circuit (IC) card on which a non-contact IC chip is mounted, an electronic device, or the like.

The connection port 923 is a port for being directly connected to the information processing apparatus 900. Examples of the connection port 923 include a universal serial bus (USB) port, an IEEE 1394 port, a small computer system interface (SCSI) port, and the like. Other examples of the connection port 923 include an RS-232C port, an optical audio terminal, a high-definition multimedia interface (HDMI) (registered trademark) port, and the like. By connecting the externally connected device 929 to the connection port 923, the information processing apparatus 900 directly acquires various data from the externally connected device 929 and provides various data to the externally connected device 929.

The communication device 925 is, for example, a communication interface configured by a communication device for being connected to a communication network (network) 931, and the like The communication device 925 is, for example, a communication card for a wired or wireless local area network (LAN), Bluetooth (registered trademark), a wireless USB (WUSB), or the like. Furthermore, the communication device 925 may be a router for optical communication, a router for an asymmetric digital subscriber line (ADSL), a modem for various communications, or the like. The communication device 925 can transmit and receive signals and the like, for example, to and from the Internet and other communication devices in accordance with a predetermined protocol such as TCP/IP, for example. Furthermore, the communication network 931 connected to the communication device 925 is configured by a network or the like connected by wire or wirelessly, and may be, for example, the Internet, home LAN, infrared communication, radio wave communication, satellite communication, or the like.

An example of the hardware configuration that can implement the functions of the information processing apparatus 900 that configures the information processing system 1 according to the embodiment of the present disclosure has been described. Each of the above-described configuration elements may be configured using general-purpose members or may be configured by hardware specialized for the function of each configuration element. Therefore, the hardware configuration to be used can be changed as appropriate according to the technical level of the time of carrying out the present embodiment. Note that various configurations corresponding to the information processing apparatus 900 configuring the information processing system 1 according to the present embodiment are naturally provided although not illustrated in FIG. 14.

Note that a computer program for implementing the functions of the information processing apparatus 900 configuring the information processing system 1 according to the above-described present embodiment can be prepared and implemented on a personal computer or the like. Furthermore, a computer-readable recording medium in which such a computer program is stored can be provided. The recording medium is, for example, a magnetic disk, an optical disk, a magneto-optical disk, a flash memory, or the like. Furthermore, the above computer program may be delivered via, for example, a network without using a recording medium. Furthermore, the number of computers that execute the computer program is not particularly limited. For example, a plurality of computers (for example, a plurality of servers or the like) may execute the computer program in cooperation with one another. Note that a single computer or a plurality of computers cooperating with one another is also referred to as a “computer system”.

An example of the hardware configuration of the information processing apparatus 900 in the case of implementing the configuration corresponding to the above-described information processing apparatus 10 as the independently operable information processing apparatus 900 such as a PC, a smartphone, or a server has been described in detail with reference to FIG. 14.

(Configuration Example in the Case of Implementing Information Processing Apparatus as Chip)

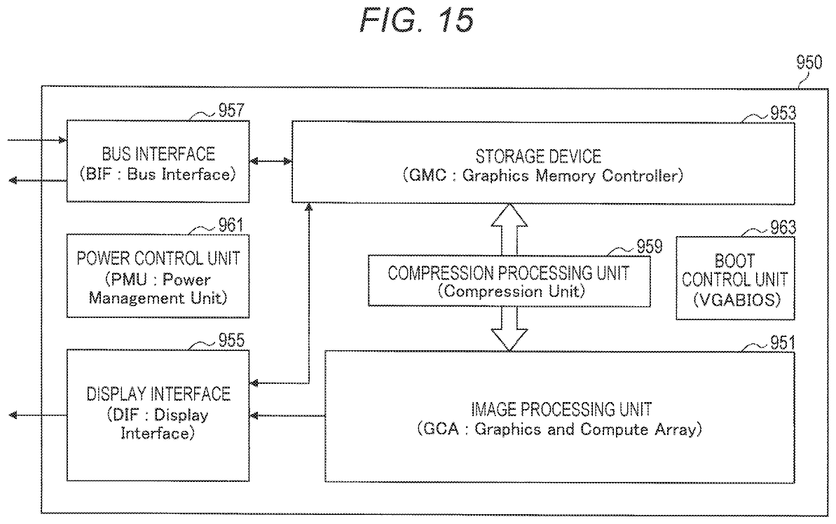

Next, an example of a hardware configuration of a chip 950 in the case of implementing the configuration corresponding to the above-described information processing apparatus 10 as a chip such as a GPU (which will be referred to as the “chip 950” for convenience) will be described in detail with reference to FIG. 15. FIG. 15 is a functional block diagram illustrating an example of a hardware configuration in the case of implementing the information processing apparatus configuring the information processing system according to the embodiment of the present disclosure as a chip.

As illustrated in FIG. 15, the chip 950 includes an image processing unit (graphics and compute array: GCA) 951, a storage device (graphics memory controller: GMC) 953, a display interface (DIF) 955, a bus interface (BIF) 957, a power control unit (power management unit: PMU) 961, and a boot control unit (VGA BIOS) 963. Furthermore, a compression processing unit (compression unit) 959 may be interposed between the image processing unit 951 and the storage device 953.

The image processing unit 951 corresponds to a processor that executes various types of processing regarding image processing. As a specific example, the image processing unit 951 executes various types of arithmetic processing such as update of the above-described scene graph (scene update), processing regarding projection of an object (vertex shader), processing regarding reprojection of an object (reprojection shader), and processing regarding drawing of the display information (pixel shader). Furthermore, at this time, the image processing unit 951 may read data stored in the storage device 953 and use the data for execution of the various types of arithmetic processing. Note that the processing of the recognition processing unit 101, the calculation unit 105, the projection processing unit 107, the correction processing unit 109, the drawing processing unit 111, and the output control unit 113, which has been described with reference to FIG. 10, can be implemented by the arithmetic processing by the image processing unit 951, for example.

The storage device 953 is a configuration for temporarily or permanently storing various data. As a specific example, the storage device 953 may store data according to execution results of the various types of arithmetic processing by the image processing unit 951. The storage device 953 can be implemented on the basis of a technology of video RAM (VRAM), window RAM (WRAM), multibank DRAM (MDRAM), double-data-rate (DDR), graphics DDR (GDDR), high bandwidth memory (HBM), or the like, for example.

The compression processing unit 959 compresses and decompresses various data. As a specific example, the compression processing unit 959 may compress data according to a calculation result by the image processing unit 951 when the data is stored in the storage device 953. Furthermore, when the image processing unit 951 reads data stored in the storage device 953, the compression processing unit 959 may decompress the data in the case where the data is compressed.

The display interface 955 is an interface for the chip 950 to send and receive data to and from a display (for example, the output unit 211 illustrated in FIG. 10). As a specific example, a result of drawing of the display information by the image processing unit 951 is output to the display via the display interface 955. Further, as another example, in the case where the result of drawing of the display information by the image processing unit 951 is stored in the storage device 953, the result of the drawing stored in the storage device 953 is output to the display via the display interface 955.

The bus interface 957 is an interface for the chip 950 to send and receive data to and from other devices and external devices. As a specific example, the data stored in the storage device 953 is transmitted to another device or an external device via the bus interface 957. Furthermore, data transmitted from another device or an external device is input to the chip 950 via the bus interface 957. Note that the data input to the chip 950 is stored in the storage device 953, for example.

The power control unit 961 is a configuration for controlling supply of power to each part of the chip 950.

The boot control unit 963 is a configuration for managing and controlling various types of processing related to boot, input/output of various types of information, and the like at the time of booting the chip 950. The boot control unit 963 corresponds to a so-called video graphics array basic input/output system (VGABIOS).

An example of the hardware configuration of the chip 950 in the case of implementing the configuration corresponding to the above-described information processing apparatus 10 as the chip 950 such as a GPU has been described in detail with reference to FIG. 15. Note that, in the present disclosure, the case of implementing the configuration as the “information processing apparatus” can include the case of implementing the configuration as a chip (in other words, components) to be incorporated in a device, as illustrated in FIG. 15, in addition to the case of implementing the configuration as one device, as illustrated in FIG. 14.

### 5. Conclusion

As described above, in the information processing system according to the embodiment of the present disclosure, the information processing apparatus acquires the first information regarding the recognition result of at least one of the position or orientation of the viewpoint. Furthermore, the information processing apparatus projects the target object on the display region on the basis of the first information, and causes the display information to be presented to the display region according to a result of the projection. At this time, the information processing apparatus projects the object to the first partial region and the second partial region included in the display region on the basis of the first information according to the recognition result at timings different from each other.

Furthermore, the information processing apparatus may control the presentation of the first display information to the first partial region according to the projection result of the object on the first partial region, and the presentation of the second display information to the second partial region according to the projection result of the object on the second partial region at timings different from each other. Furthermore, the information processing apparatus may control the presentation of the display information to the partial region of at least one of the first partial region or the second partial region according to a timing when the result of projection of the object on the partial region is acquired.

With the above configuration, the information processing system according to the embodiment of the present disclosure can present the display information according to the position or orientation of the viewpoint in a less logically broken mode even in the situation where the position or orientation of the viewpoint may sequentially change. In particular, according to the information processing system of the embodiment of the present disclosure, information can be presented in a less logically broken mode than the case where rendering (in particular, projection of an object) is performed for each frame as in a conventional case even in the situation where the position or orientation of the viewpoint significantly changes between frames. That is, the information processing system according to the embodiment of the present disclosure can implement the presentation of information according to the position or orientation of the viewpoint in a more favorable mode.

Note that the above description has been made about the characteristics of the information processing system according to the embodiment of the present disclosure, using the case of mainly presenting information on the basis of the AR technology as an example. However, the application destination of the information processing system is not necessarily limited to the case of presenting information on the basis of the AR technology. That is, the information processing system according to the embodiment of the present disclosure can be applied not only to the case of presenting information on the basis of the AR technology but also to the case of presenting information on the basis of the VR technology. Note that, in the case of applying the information processing system according to the embodiment of the present disclosure to the case of presenting information on the basis of the VR technology, the configuration of the information processing system may be appropriately changed in part within a range not deviating the idea described as the basic principle of the technology according to the present disclosure.

Although the favorable embodiment of the present disclosure has been described in detail with reference to the accompanying drawings, the technical scope of the present disclosure is not limited to such examples. It is obvious that persons having ordinary knowledge in the technical field of the present disclosure can conceive various changes and alterations within the scope of the technical idea described in the claims, and it is naturally understood that these changes and alterations belong to the technical scope of the present disclosure.

Furthermore, the effects described in the present specification are merely illustrative or exemplary and are not restrictive. That is, the technology according to the present disclosure can exhibit other effects obvious to those skilled in the art from the description of the present specification together with or in place of the above-described effects.

Note that following configurations also belong to the technical scope of the present disclosure.

(1)

An information processing apparatus including:

an acquisition unit configured to acquire first information regarding a recognition result of at least one of a position or an orientation of a viewpoint; and

a control unit configured to project a target object on a display region on the basis of the first information and cause display information to be presented to the display region according to a result of the projection, in which

the control unit projects the object on a first partial region and a second partial region included in the display region on the basis of the first information according to the recognition result at timings different from each other.

(2)

The information processing apparatus according to (1), in which

the control unit controls

presentation of first display information to the first partial region according to a projection result of the object on the first partial region, and

presentation of second display information to the second partial region according to a projection result of the object on the second partial region

at timings different from each other.

(3)

The information processing apparatus according to (2), in which the control unit controls presentation of the display information to a partial region of at least one of the first partial region or the second partial region according to a timing when a result of projection of the object on the partial region is acquired.

(4)

The information processing apparatus according to (3), in which, when a frame rate related to the presentation of the display information to the partial region is reduced to a first frame rate, the control unit sets a second frame rate related to projection of the object on a partial region of at least one of the first partial region or the second partial region to be larger than the first frame rate.

(5)

The information processing apparatus according to (3) or (4), in which

the control unit executes

first processing of sequentially executing projection of the object on the first partial region based on the first information according to the recognition result at a first timing and presentation of the first display information according to a result of the projection to the first partial region, and

second processing of sequentially executing projection of the object on the second partial region based on the first information according to the recognition result at a second timing and presentation of the second display information according to a result of the projection to the second partial region

at timings different from each other.

(6)

The information processing apparatus according to (5), in which the control unit executes the first processing and the second processing in a predetermined order for each predetermined unit period.

(7)

The information processing apparatus according to (6), in which

the second timing is a timing later than the first timing, and

the control unit executes the second processing after executing the first processing.

(8)

The information processing apparatus according to any one of (5) to (7), in which the control unit estimates a processing time for processing of at least one of the first processing or the second processing, and starts processing regarding presentation of the display information to a corresponding partial region before the first information corresponding to the processing of at least one of the first processing or the second processing is acquired according to an estimation result of the processing time.

(9)

The information processing apparatus according to any one of (5) to (7), in which the control unit estimates a processing time for processing of at least one of the first processing or the second processing, and skips execution of the processing according to an estimation result of the processing time.

(10)

The information processing apparatus according to (9), in which, in the case where the control unit has skipped execution of the processing of at least one of the first processing or the second processing, the control unit causes another display information to be presented in a corresponding partial region instead of the display information presented by the processing.

(11)

The information processing apparatus according to any one of (2) to (10), in which

the first partial region and the second partial region are regions adjacent to each other, and

the control unit corrects at least one of the first display information or the second display information such that the first display information and the second display information are presented as a series of continuous display information.

(12)

The information processing apparatus according to any one of (1) to (11), in which the control unit acquires a projection result of the object on the display region by projecting the object on a projection surface associated with the display region.

(13)

The information processing apparatus according to (12), in which the control unit projects the object on the projection surface according to a relationship of at least one of positions or orientations among the viewpoint, the projection surface, and the object based on the first information.

(14)

The information processing apparatus according to any one of (1) to (13), in which the first partial region and the second partial region include one or more unit regions different from one another among a plurality of unit regions configuring the display region.

(15)

The information processing apparatus according to (14), in which the unit region is either a scan line or a tile.

(16)

The information processing apparatus according to any one of (1) to (15), in which

the object targeted for the projection is a virtual object,

the acquisition unit acquires second information regarding a recognition result of a real object in a real space, and

the control unit

associates the virtual object with a position in the real space according to the second information, and

projects the virtual object on the display region on the basis of the first information.

(17)

The information processing apparatus according to (16), in which the control unit associates the virtual object with the position in the real space so that the virtual object is visually recognized to be superimposed on the real object.

(18)

The information processing apparatus according to any one of (1) to (17), further including:

a recognition processing unit configured to recognize at least one of the position or the orientation of the viewpoint according to a detection result of a detection unit, in which

the acquisition unit acquires the first information according to a result of the recognition.

(19)

An information processing method including:

by a computer,

acquiring first information regarding a recognition result of at least one of a position or an orientation of a viewpoint; and

projecting a target object on a display region on the basis of the first information and causing display information to be presented to the display region according to a result of the projection, in which

the object is projected on a first partial region and a second partial region included in the display region on the basis of the first information according to the recognition result at timings different from each other.

(20)

A program for causing a computer to:

acquire first information regarding a recognition result of at least one of a position or an orientation of a viewpoint; and

project a target object on a display region on the basis of the first information and cause display information to be presented to the display region according to a result of the projection, in which

the object is projected on a first partial region and a second partial region included in the display region on the basis of the first information according to the recognition result at timings different from each other.

### REFERENCE SIGNS LIST

1 Information processing system
10 Information processing apparatus
101 Recognition processing unit
105 Calculation unit
107 Projection processing unit
109 Correction processing unit
111 Drawing processing unit
113 Output control unit
115 Processing block
117 Processing block
20 Input/output device
201 Imaging unit
207 Operation unit
211 Output unit
251 Detection unit
291 Holding unit
293a, 293b Lens

1. An information processing apparatus comprising:
an acquisition unit configured to acquire first information regarding a recognition result of at least one of a position or an orientation of a viewpoint; and
a control unit configured to project a target object on a display region on a basis of the first information and control display information to be presented to the display region according to a result of the projection, wherein
the control unit projects the object on a first partial region and a second partial region included in the display region on a basis of the first information according to the recognition result at timings different from each other.

2. The information processing apparatus according to claim 1, wherein
the control unit controls
presentation of first display information to the first partial region according to a projection result of the object on the first partial region, and
presentation of second display information to the second partial region according to a projection result of the object on the second partial region
at timings different from each other.

3. The information processing apparatus according to claim 2, wherein the control unit controls presentation of the display information to a partial region of at least one of the first partial region or the second partial region according to a timing when a result of projection of the object on the partial region is acquired.

4. The information processing apparatus according to claim 3, wherein, when a frame rate related to the presentation of the display information to the partial region is reduced to a first frame rate, the control unit sets a second frame rate related to projection of the object on a partial region of at least one of the first partial region or the second partial region to be larger than the first frame rate.

5. The information processing apparatus according to claim 3, wherein
the control unit executes
first processing of sequentially executing projection of the object on the first partial region based on the first information according to the recognition result at a first timing and presentation of the first display information according to a result of the projection to the first partial region, and
second processing of sequentially executing projection of the object on the second partial region based on the first information according to the recognition result at a second timing and presentation of the second display information according to a result of the projection to the second partial region
at timings different from each other.

6. The information processing apparatus according to claim 5, wherein the control unit executes the first processing and the second processing in a predetermined order for each predetermined unit period.

7. The information processing apparatus according to claim 6, wherein
the second timing is a timing later than the first timing, and
the control unit executes the second processing after executing the first processing.

8. The information processing apparatus according to claim 5, wherein the control unit estimates a processing time for processing of at least one of the first processing or the second processing, and starts processing regarding presentation of the display information to a corresponding partial region before the first information corresponding to the processing of at least one of the first processing or the second processing is acquired according to an estimation result of the processing time.

9. The information processing apparatus according to claim 5, wherein the control unit estimates a processing time for processing of at least one of the first processing or the second processing, and skips execution of the processing according to an estimation result of the processing time.

10. The information processing apparatus according to claim 9, wherein, in the case where the control unit has skipped execution of the processing of at least one of the first processing or the second processing, the control unit causes another display information to be presented in a corresponding partial region instead of the display information presented by the processing.

11. The information processing apparatus according to claim 2, wherein
the first partial region and the second partial region are regions adjacent to each other, and
the control unit corrects at least one of the first display information or the second display information such that the first display information and the second display information are presented as a series of continuous display information.

12. The information processing apparatus according to claim 1, wherein the control unit acquires a projection result of the object on the display region by projecting the object on a projection surface associated with the display region.

13. The information processing apparatus according to claim 12, wherein the control unit projects the object on the projection surface according to a relationship of at least one of positions or orientations among the viewpoint, the projection surface, and the object based on the first information.

14. The information processing apparatus according to claim 1, wherein the first partial region and the second partial region include one or more unit regions different from one another among a plurality of unit regions configuring the display region.

15. The information processing apparatus according to claim 14, wherein the unit region is either a scan line or a tile.

16. The information processing apparatus according to claim 1, wherein
the object targeted for the projection is a virtual object,
the acquisition unit acquires second information regarding a recognition result of a real object in a real space, and
the control unit
associates the virtual object with a position in the real space according to the second information, and
projects the virtual object on the display region on a basis of the first information.

17. The information processing apparatus according to claim 16, wherein the control unit associates the virtual object with the position in the real space so that the virtual object is visually recognized to be superimposed on the real object.

18. The information processing apparatus according to claim 1, further comprising:
a recognition processing unit configured to recognize at least one of the position or the orientation of the viewpoint according to a detection result of a detection unit, wherein
the acquisition unit acquires the first information according to a result of the recognition.

19. An information processing method comprising:
by a computer,
acquiring first information regarding a recognition result of at least one of a position or an orientation of a viewpoint; and
projecting a target object on a display region on a basis of the first information and causing display information to be presented to the display region according to a result of the projection, wherein
the object is projected on a first partial region and a second partial region included in the display region on a basis of the first information according to the recognition result at timings different from each other.

20. A program for causing a computer to:
acquire first information regarding a recognition result of at least one of a position or an orientation of a viewpoint; and
project a target object on a display region on a basis of the first information and cause display information to be presented to the display region according to a result of the projection, wherein
the object is projected on a first partial region and a second partial region included in the display region on a basis of the first information according to the recognition result at timings different from each other.
